(19) United States
(12) Patent Application Publication
(10) Pub. No.: US 2007/0168668 A1
(43) Pub. Date: Jul. 19, 2007

(54) Media card with command pass through mechanism

(76) Inventors: Robert C. Chang, Danville, CA (US); Henry Ricardo Hutton, Tracy, CA (US); Farshid Sabet Sharghi, Los Altos Hills, CA (US); Haluk Kent Tanik, Mountain View, CA (US); Ron Barzilai, Kfar-Vradim (IL); Meytal Dam Ari, Maalot (IL)

Correspondence Address: PARSONS HSUE & DE RUNTZ, LLP - SANDISK CORPORATION, 595 MARKET STREET, SUITE 1900, SAN FRANCISCO, CA, 94105, US

(21) Appl. No.: 11/299,186

(22) Filed: Dec. 8, 2005

(51) Int. Cl. H04L 9/00

(52) U.S. Cl. 713/176

(57) ABSTRACT

The present invention presents techniques for transmitting application specific instruction between a host and a memory card. The commands for the application specific protocol are embedded along with a signature in the data portion of a transmission protocol that is used to communicate between the host the memory card. This allows for the transmission of application specific commands that lack a corresponding command in the transmission protocol to still be transmitted in that protocol. The method can be implemented on the host side either at the device driver level or the file level. In order to implement a read command in the application specific protocol, a write command in the first protocol with an embedded read command is first sent to a logical address, followed by a second read command to the same logical address.

### CROSS-REFERENCE TO RELATED APPLICATION

The present application is related to U.S. application Ser. No. ______, of Chang et al., entitled “Media Card with Command Pass Through Methods,” which is filed concurrently with the present application and is hereby incorporated herein, in its entirety, by this reference.

### BACKGROUND OF THE INVENTION

This invention relates, generally, to the use and structure of removable electronic circuit cards and, more specifically, to allow personal computers or other hosts to use media specific card commands through a reader and/or host software that does not support these commands.

Recently, the small-format flash memory cards, such as the Compact Flash Card, Secure Digital (SD) Card, the Multi-media Card (MMC), xD, and the Sony Memory Stick/Memory Stick Pro, have achieved wide consumer acceptance. These devices are primarily designed for consumer electronic devices such as digital cameras and flash-memory music players. However, it is desirable that they also have convenient connections to personal computers for uploading and downloading data.

The different cards have different electrical interfaces and often commands specific to the media that can be used a host for the card. Further, card protocols may not only differ between card form factors, but also between various cards of the same form factor, since these cards are started to be overloaded with additional functions which may differ from one card to another. The commands often have unique functions such as special input-output (I/O) and security operations. As the uses of such cards become more diverse and they are used in ever more types of applications, these new applications will often involve functions or commands that are lacking in existing protocols.

Examples of commercially available non-volatile memory cards that have different mechanical and/or electrical interfaces include the related MultiMediaCard (“MMC”) and Secure Digital (“SD”) memory cards that are available from SanDisk Corporation of Sunnyvale, Calif., assignee of the present application. There are other cards that conform to standards of the International Organization for Standardization (“ISO”) and the International Electrotechnical Commission (“IEC”), an example that is widely implemented being known as the ISO/IEC 7816 standard.

The physical and electrical specifications for the MMC are given in “The MultiMediaCard System Specification” that is updated and published from time-to-time by the MultiMediaCard Association (“MMCA”) of Cupertino, Calif. Versions 2.11 2.2, 3.1, and 4.0 of that Specification, dated June 1999, January 2000, June 2001, and February 2004 respectively, are expressly incorporated herein by this reference. MMC products having varying storage capacity up to 128 megabytes in a single card are currently available from SanDisk Corporation. These products are described in a “MultiMediaCard Product Manual,” Revision 2, dated April 2000, published by SanDisk corporation, which Manual is expressly incorporated herein by this reference. Certain aspects of the electrical operation of the MMC products are also described in U.S. Pat. No. 6,279,144 and the application Ser. No. 09/186,064, filed Nov. 4, 1998. The physical card structure and a method of manufacturing it are described in U.S. Pat. No. 6,040,622. These applications and patents assigned to SanDisk Corporation are expressly incorporated herein by this reference.

The newer SD Card is similar to the MMC card, having the same size except for an increased thickness that accommodates an additional memory chip. A primary difference between them is that the SD Card includes additional data contacts in order to enable faster data transfer between the card and a host. (A version of the MMC card with additional data contact is also available—see version 4.0 of the MMC specification cited above.) The other contacts of the SD Card are the same as those of the MMC card in order that sockets designed to accept the SD Card will also accept the MMC card. The electrical and functional interface with the SD card is further made in such a way that the sockets designed to accept the SD card can also be made to accept the MMC card, as is described in U.S. Pat. No. 6,820,148, hereby incorporated by this reference. Certain aspects of the SD card are described in U.S. patent application Ser. No. 09/641,023, filed Aug. 17, 2000, which application is incorporated herein by this reference. (The specifications of the SD card are available to member companies of the SD Association (SDA).)

Cards made according to the ISO/IEC 7816 standard are of a different shape, have surface contacts in different positions, and a different electrical interface than the MMC and SD Cards. The ISO/IEC 7816 standard has the general title of “Identification cards—Integrated Circuit(s) Cards with Contacts,” and consists of parts 1-10 that carry individual dates from 1994 through 2000. This standard, copies of which are available from the ISO/IEC in Geneva, Switzerland, is expressly incorporated herein by this reference. ISO/IEC 7816 cards are particularly useful in applications where data must be stored in a secure manner that makes it extremely difficult or impossible for the data to be read in an unauthorized manner. The small ISO/IEC 7816 cards are commonly used in cellular telephones, among other applications. As noted above, as such memory cards are used in new applications, they may have a need of functions or commands lacking in the existing version of a protocol. This situation can be illustrated with respect to FIG. 1. As shown on the upper portion of FIG. 1, the goal is the exchange of commands and data between a particular application, say in a secure data transfer or e-commerce application, on the host side and on the card side. To implement this, the commands will need to be transmitted between the host and the card, where the lower portion of FIG. 1 shows some of the software layers on the host side and some of the firmware layers on the card side. An instruction from the host's application layer will be passed through the operating system, file layer and the device (card) driver, ending up in protocol in which it can be transmitted to the card. Within the card, the instruction will then be taken up by the device layer firmware, which handles standard card operations and passed on to the application layer of the firmware. Depending on the arrangement being used, the instructions in the transmission protocol will wither be exchanged directly from the host to the card or through a reader or hardware adapted, which may have its own software/firmware layers used to translate from one protocol to another. Where problems can arise is that at some stage in the translation between these layers, the intended instruction of the application may lack a corresponding command at some point along the way.

As one example, a card is often connected with a PC host through use of a hardware adapter (e.g. for USB) that accepts commands from the host system. However, many of the media specific commands are not available in the protocol by which the host and the hardware adapter communicate, even though the host application of the PC host wants to transmit these commands to the card application.

FIG. 2 shows a system of a first host and a card, where the card 101 is connectable to the host 151 either directly, for example by insertion into the slot 153, or through some sort of adapter. The card firmware is indicated by FW 105. (Both with respect to card firmware 105 and reader firmware 335 in FIG. 3, it will be understood that, more generally, these functions can be implemented in hardware, software, or some combination of these.) An example of such a host 151 could be a digital camera or a telephone. A number of types of such cards are in current use and being developed. The card and host can communicate through a number of specific protocols, many of which are specific to particular media and which may include various media specific commands. Since many of the commands may be media specific, there can arise cases where, when such a command is to be exchanged between a host and the media, somewhere along the line the command will need to be translated into another protocol, which may not support the media specific command. If this other protocol does not have a corresponding command, the host will not be able to successfully issue the command.

For example, in addition to its use in a host, it is also common for a user to access a card on a personal computer. For example, it is common for a card that has been used in, say, a digital camera and want to access the photos stored in the card on a personal computer. This situation is shown by the box diagram of FIG. 3. The card 101 is typically put into communication with the personal computer PC 351 through of a card reader 331 having a receptacle 333 for the card 101, although in other cases the card may be directly attached to PC 351. The reader 331 and PC 351 will typically communicate through a protocol that, at least to some extent, differs from that used by the card 101 to communicate with the host 151. The reader 331 translates a command from the PC 351 into a form suitable for the card 101 based on firmware 335 (or hardware, software or some combination of these), where it is generally understood that this function can be performed any combination of soft- and hardware, depending on the implementation. This process is shown schematically in FIG. 4.

To give a concrete example, in FIG. 4 the reader 331 will be taken as a USB device that communicates with the PC 351 using the SCSI command set and the card 101 will be taken as an SD card. As the PC 351 and reader 331 uses the SCSI protocol, when the host wants to issue a command to the card through the reader, it issues command 401 in the SCSI command set. To transfer the command 401 to the reader, it is placed in an USB wrapper 403, transmitted along the USB connection to the reader, and there the USB wrapper is removed. The card reader 331 will then translate the command 401 from the SCSI command set into the corresponding command or commands 405 in the SD set, allowing it to be passed on to the card 101; however, for the reader to translate a given command between the SCSI command set and the SD command set, there needs to be an equivalent command in both sets. Consequently, if the host wants to perform, for example, a read of the secure area in the SD card by issuing a secure read command in the SD protocol, as there is no such SCSI equivalent, there is no way for the reader to translate this as it is not found in the SCSI command set and the read request will be considered to be to an area for which the user has insufficient access rights. The same situation will arrive for other media specific command for various card types where there is no equivalent SCSI command or commands for the host to send to reader in a protocol it understands.

Consequently, such media card specific command can not be passed to the card from the host without changing the firmware of the adapter or the reader which hosts the media card to introduce corresponding commands for the protocol it uses to communicate with the host. Similar situations can also arise, even without a separate card reader, whenever a protocol change is need somewhere along the communication path or when the host's operating system is unaware of card features.

In the prior art, the approach to this problem would be to either change the adapter firmware to support special commands for passing such instructions through the adapter or create new commands in the reader-host protocol, each tailored to the specific media command such as those corresponding, for example, to send challenge command, receive response command, etc. in the SD card's protocol. These approaches tend to be impractical for a number of reasons. For one, the protocols are usually based on a standard which, to be useful, needs to be broadly accepted and usually tending to prefer less complicated command sets; consequently, it is difficult to introduce various new, media specific commands into the command set as new media are introduced and existing media evolve. If instead the adapter's firmware is changed to allow for special commands to pass through those media specific commands that it does not itself support, the software of each vendor for such adaptors would need to accept and make the appropriate firmware changes. Consequently, it would be of great benefit to introduce methods whereby the personal computer could utilize the various media specific commands without having to change either the reader's firmware or the host-reader protocol.

More generally, even when the card is in direct connection with the host, as new application specific commands are introduced, protocols would need to be updated. Even though an existing protocol can be expanded and standardized to incorporate the new functions, this introduces compatibility with problems with older versions or those other vendors, largely undermining the utility of a standardized protocol. Further, although the protocols may be adapted to new applications, this is likely to only be a temporary solution as ever more applications arise to extend the uses of cards. Consequently, there is similarly a need to accommodate the case where the host's operating system does not support the media specific commands.

### SUMMARY OF THE INVENTION

Therefore, the present invention, briefly and generally, provides methods and techniques whereby a device (such as a memory card or other integrated circuit card) can exchange application or media specific commands with a host. The host and card can either communicate directly or through a reader or hardware adapter, transmitting the application specific commands through a protocol that does not have an equivalent of the media specific command. For example, in one embodiment, a PC can make a read of the secure data area of an SD (Secure Digital) memory card through a card reader even though the card reader does not support such a command.

More specifically, the host forms an instruction having a command in a protocol that is supported along the communication path between the host and the card, while the actual, media or application specific command is embedded in the instruction. In the exemplary embodiments, the media specific command is embedded in the data portion of the instruction. The card then receives the instruction in the protocol through which it communicates with the host and translates it into the application's protocol. The embedded command is passed through in a transparent manner; for example, the transmission protocol just passes on to the card what it considers to be data, when it may actually contain the media specific command. Once in the card, it recognizes that the actual command is embedded within the instruction and proceeds to extract it. This is done by determining that the data portion of the command contains a signature: if the signature is found, the embedded command is extracted and executed; if no signature is found, the command of the transmission protocol is executed. In the exemplary embodiments, the signature and embedded command are placed in the first sector of the data portion. The conversion is implemented on the device side, where the actual command is extracted, and in the host side, where the command is embedded either at the device driver level or the file system level. The device driver level implementation addresses commands to a specific logical block address, while at the file level any logical block address can be used. Although the device driver level implementation requires less overhead, in many operating system it may require access privileges that the user lacks.

The various aspects of the present invention are not just limited to the case of a card protocol having commands without equivalents in the protocol used between a host and a hardware card reader, but in other cases where an intermediate protocol needs to carry a command that it lacks. A first set of embodiments considers the case where the card can communicate directly with the host in its own protocol, but the card (or other device) has an application with an additional set of features that require an additional set of commands to be used. These commands are not part of the standard protocol used by the host and card to communicate or are not supported by standard operating system on the host. Consequently, special means are required to pass these commands back and forth between the application on the card (implementable at firmware level) and the application on the host (implementable at software level). In a principle aspect of the present invention, the application commands are embedded in the data portion of an instruction in the intermediate protocol, which in this case is the card protocol. In another aspect of the present invention, this is achieved by having a set of commands related to opening, closing, and managing a path from the host application to the device.

A second exemplary embodiment is implemented at the device (card) driver level and uses an instruction that specifies a specific logical block address (LBA), a Card Pass Through (CPT) Mode LBA, with a special signature in the data sector to notify the card that a special command is embedded in the sector. This can be implemented as a change in the card's firmware so that it supports the CPT mode. This eliminates the need to change the firmware of the adapter according to each media specific command, so that the card can be run at any, say, USB reader or adapter without having to make media specific adaptations (or to change the host's operating system (OS) so that the card can be used under any OS). The card firmware continues to honor the normal read/write command. With the read/write command to a specific LBA offset, a signature is checked to determine if the data contains the embedded media card specific commands. The protocol can be implemented in the firmware of any media card. Therefore, it does not require firmware change to the adapter or the USB or other reader or host OS, without the changes to reader firmware.

A third set of exemplary embodiments is implemented at the file level on the host side. The media specific command is again embedded in the intermediate protocol, but rather than relying on the hardware specifics and referencing particular protocols, the embedded command and any accompanying data are all placed into the data portion of a file which is then transferred to the media, where the firmware again extracts the actual command. In these embodiments, the host simply tells the file system to write a file to memory device, where the device specific command is again embedded in the data portion. With a read/write command to any LBA, as opposed to a specific logical address, the device checks for a signature to determine if the data contains embedded media card specific commands. An exemplary embodiment places this signature in the first sector of data in any file associated with a write command. If the appropriate signature is found, the embedded command is extracted; if no signature is found, the command is interpreted as a standard command of the intermediate protocol. In this way, the file level embodiments of the present invention allows the circumvention of a privileges problem that arise to the use of a specific logical address in the device level applications, as writing a file to the device is generally allowed in operating systems.

In all of the exemplary embodiments, the embedded command is placed in the data portion of a write command in the intermediate protocol. For example, write command of, say, N sectors in the device or application specific protocol would consist of a write command in the intermediate protocol having (N+1) sectors of data, the first sector containing the actual, embedded write command and the remaining N sectors the actual data to be written. More generally, the command (and signature), along with any data to be transferred to the device by embedded command, can be placed in any command that accepts an associated data portion. To implement a read or other command in the device or application specific protocol that requires data to be transferred from the device to the host, the exemplary embodiment use a pair of commands: the first command will again be a write command in the intermediate protocol with one sector of data, corresponding to the embedded read command (and no real data associated with the embedded read); the actual transfer of data from the device to the host is then effected by a second command, a host read addressed to the same logical address as the first command.

Additional details, features and advantages of the present invention will become apparent from the following description, which should be taken in conjunction with the accompanying drawings.

### BRIEF DESCRIPTION OF THE DRAWINGS

FIG. 1 is a schematic representation of the layers of a host-card system.

FIG. 2 is a block diagram of a host-card system.

FIG. 3 is a block diagram of a system where the card communicates with another host using a reader or hardware adapter.

FIG. 4 is a schematic representation of the prior art techniques for the transfer of data and commands in the system of FIG. 3.

FIG. 5 shows how application specific commands can be embedded according to an exemplary embodiment of the present invention.

FIG. 6 is a block diagram showing an exemplary structure for the relation of the firmware layers.

FIG. 7 is a schematic representation of device driver layers.

FIG. 8 shows the information contained in response to a partition status command.

FIG. 9 shows an exemplary format for the argument data sector.

FIGS. 10A and 10B show host side communication flows.

FIGS. 11A-C illustrate the host application-device application protocol.

FIG. 12 is a state machine diagram for the hidden partition application's commands.

FIGS. 13A-D show the process flows for a set of commands in the hidden partition protocol.

FIG. 14 is a simplified version of FIG. 4.

FIG. 15 is a schematic representation of techniques for the transfer of data and commands in the system of FIG. 3 according to aspects of the present invention.

FIG. 16 provides details of FIG. 15 according to particular embodiments.

FIGS. 17A-L give specifics of the structure of the embodiments for FIG. 16 for a number of commands.

FIGS. 18A-H are similar to FIGS. 17A-L for a file level embodiment.

### DESCRIPTION OF SPECIFIC EMBODIMENTS

In a primary aspect, the present invention allows for commands that are not part of the standard card protocol (or are not supported by standard OS on the host) to passed back and forth between the application on the host (typically as the software that uses the application on the card) and the application on the card (typically as the card's firmware implementing these additional features as a specific application on the card). The exemplary embodiment accomplishes this by embedding the special commands in a standard command, such as a write, that any host supports. This allows memory cards, such as described in the Background section, to be recognized, interfaced, and used, on all standard host devices and PCs while allowing additional, non-standard features that are not supported as a standard to be incorporated into the system.

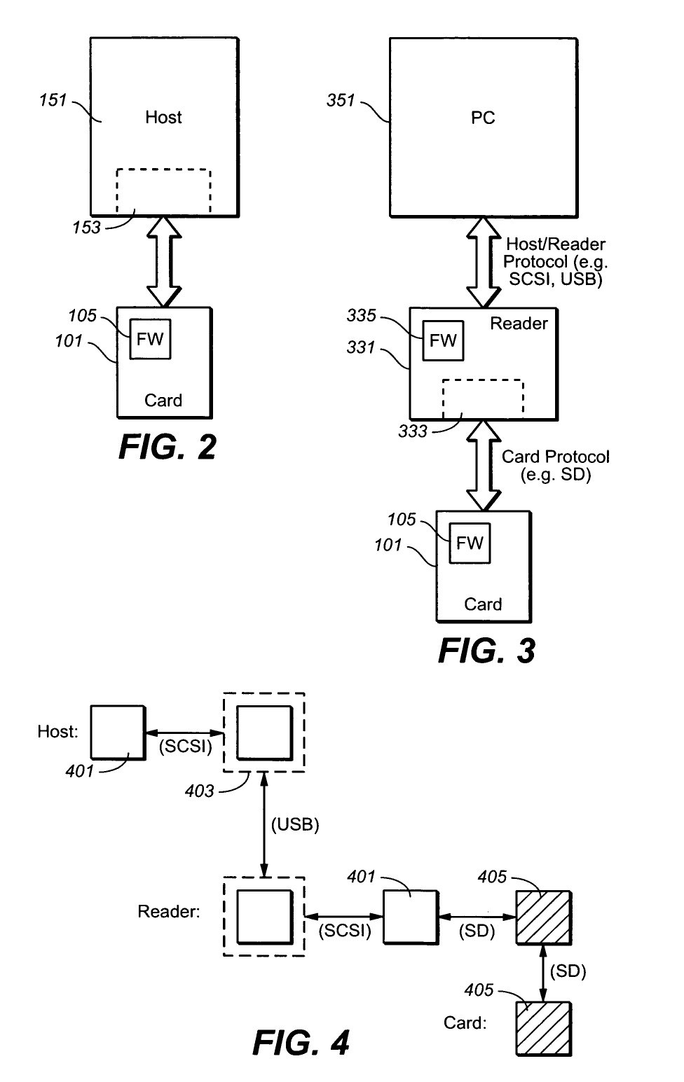

As a concrete example, referring to the specific case discussed in the Background with respect to FIGS. 2-4, these methods allow commands specific to an SD card, such as a secure read, to be transmitted through a USB protocol, which lacks an equivalent command. In general terms, this is accomplished by forming an instruction that consists of a command portion, which exists in the transmission protocol, and a data portion, in which is embedded the media specific command. For example, as a write command is basic to any memory card system, it will exist in the transmission protocol and has an associated data part. The actual, application specific command is placed in the data part along with a signature to indicate that the media specific command is to be executed. Any data associated with the actual, embedded media specific command that is to be transferred to the device is also placed in the data portion of the transmission protocol's command. For the SD/USB example, to send a write read of ten sectors to an SD card within the USB protocol, an instruction is issued in the USB protocol composed of a command and eleven sectors of data: the first data sector contains the actual SD secure write command, along with a signature and related information, and is followed by the ten sectors of data to be written. When received in the card, the firmware extracts the actual secure write command, checks the signature, and executes the read of the data.

For reads (and other commands that transfer data from the device to the host), a write command in the intermediate protocol can again be used to carry the embedded read command, but, as this has no provision for data to be transferred back to the host, it is now paired with a second, read command in the intermediate protocol. More specifically, the first command of the pair will be a write (in the intermediate protocol) from the host with an embedded read command to a logical block address LBA=XYZ. In an implementation at the device driver level, it will be to a particular address, while for a file level implementation, this can be any address. The second command of the pair is then a standard host read to this same address, LBA=XYZ. The specified data is then transferred to the host.

More generally, the present invention allows application or media specific instructions to be exchanged between host and card by embedding the desired command, along with any accompanying data, within an instruction of an intermediary or transmission protocol that is usable by the system. The specific commands are resolved between the specific application running on the host on one side and corresponding application on the specific card on the other. At intermediate points along the transmission path, the instruction appears as normal command with the intermediate protocol, the actual application specific command being passed through in a transparent manner. In the exemplary embodiments, this is done by using a command in the transmission protocol that accepts a data portion, such as a write command, and embedding the actual application or media specific command in this data portion. (In some ways, this is a broadening of the invention described in co-pending, co-assigned U.S. patent application Ser. No. 10/256,689, filed Sep. 26, 2002, which is hereby incorporated by reference.) When the instruction (in the transmission protocol) arrives at the card, the data portion is checked to see whether it contains an appropriate signature and, if so, the embedded command is extracted. This is shown schematically in FIG. 5.

FIG. 5 is a schematic representation of how an application specific command is, according a particular embodiment of the present invention, embedded within the protocol used pass the protocol from the host application to the card side of the application. Consider the case where the application or media specific instruction has a command portion, CMD, and some corresponding data. For example, CMD could be an application specific write. To transmit this instruction, the host side will take a command in the transmission protocol, call it CMD′, that has a corresponding data portion, for example a write command. Whatever is placed into the data portion of this instruction will simply passed through; consequently, if the actual intended application specific command CMD (along with its corresponding data) is embedded in this data portion, it will be transmitted to the card even if the command CMD is not recognized in the transmission protocol. Once in the card, the command CMD will need to extracted from the data portion. This is done by placing a card pass through signature (CPT signature) into the data portion as well: When an incoming instruction arrives on the card, the data portion is checked for the signature and, if found, the actual command is then extracted.

In FIG. 5, the instruction in the transmission protocol containing the embedded command is shown at 510. The command portion 511 has command CMD′ and can be considered a sort of “dummy” command that will not actually be executed, but serves to pass the data portion 513 to the card side. The data portion 513 can be broken down into a first part 513a with the signature and the actual command CMD and a second part 513b of the any data corresponding to CMD. For example, if CM is a type of write command, 513b would be the data to be written, while if it were, say, a status check 513b would be absent. (As described further below, an embedded read command is somewhat more involved as, in this embodiment, it involves sending a write command CMD′ in section 511 of the transmission protocol with the embedded read command CMD in section 513a of the data portion and no real data portion 513b.) On the card side, 513a is then checked for a signature and if not found the command CMD′ is executed with all of 513 as data. If the signature is found, the actual instruction 530, having command portion 531 with command CMD and any corresponding data in data portion 533, is extracted. (In protocols that have sufficient room in their command portion 511, such as the SCSI protocol, it is also possible to embed the CPT signature, the command CMD, or both in the command portion of the transmission protocol rather than in the data portion.)

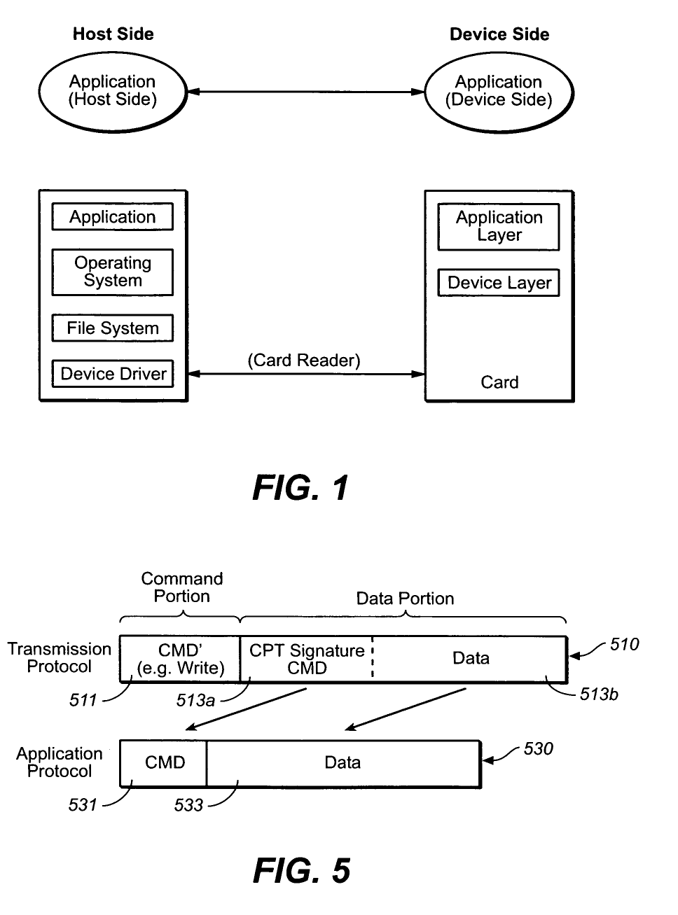

Returning to FIG. 1 and the more abstract description of the present invention, present invention allows the host side of the application to communicate with the card side even if they need to communicate with each other using, somewhere along the path, a protocol not adapted to the application. This can be the case when an adapter is unaware of card features, as described in the Background, but also when the host operating system is unaware of card features. This solves the issue of media or application specific commands both for systems with or without a host adapter that resides between the host and the card. Further, it allows for the case where the card protocol may not only differ between card form factors, but also between various cards of the same form factor as these cards are becoming overloaded with additional functions which may differ from one card to another. The presented arrangement allows for a system where the card adapter and the host OS are indifferent to the specific card protocol, with the specific commands being resolved between the specific application running on the host on one side and the specific card on the other.

On the host side, the invention can be implemented either at the file system level, where in the file mode the application is using the host file system and writing to files, or at the device driver level, in a mode using the device driver. Particular examples of both versions are given below. Which type of embodiment is preferable will often depend on specifics such as the particular application and details of the operation system. For example, an implementation at the device driver level often is simpler and requires less software/firmware overhead, but uses writing directly to a logical address; however, such a directed write requires administrator privileges that a user will lack. By instead using an implementation at the file system level can avoid these complications, but at the cost of additional overhead.

The present invention will be illustrated by a more detailed description of three specific embodiments. All of these allow special, nonstandard features to be implemented in the card to be used on the host without changing the host card protocol to support the new features or while using it through intermediate software/hardware that does not support the additional protocol. The second and third sets of embodiments describe two methods implemented on the host side (at the device driver level and file system level, respectively) while the first describes the card side implementation. This first embodiment complements the second and third and describes how the card side operates and will also be used to provide more general detail for all of the embodiments. As described more in the following, this is done using standard available commands to envelop the nonstandard commands. For each of these cases, the exemplary embodiment chooses a standard read write, which is supported everywhere. It should be noted that, in these particular embodiments, the card need not recognize the concept of files as in all of these embodiments the card sees a write to a particular logical block address (LBA). This LBA can either be specifically allocated (or reallocated) for this purpose, as in the device driver mode, or any address, in the file driver mode. The main difference is on the host side where, in the file mode, the application is using the host file system and writing to files, whereas in the first mode it is using the device driver and writing directly to an LBA.

In the following, the various aspects of the present invention are presented in examples of a number of specific embodiments. For example, the embodiments have embedded the media specific command in the data portion of a write command; more generally, the media or application specific commands can be embedded in other commands. Also, the discussion in the Background was based on a particular hardware arrangement with specific protocol domains; namely, where the PC/host communicates with the card through a hardware reader using one protocol between the host and the reader and a second protocol between the reader and the card. These embodiments can all be generalized and extended in a number of ways.

The Background discussion focused on examples where the card and PC communicate through a reader. More generally, the various aspect of the present invention apply when, somewhere in the path between the host (e.g., PC) and the ultimate destination, a protocol is used that does not have the equivalent of one or more commands that need to be transmitted. As noted, besides the problem arising when the hardware card reader communicates with the host in a protocol (e.g., USB/SCSI) with no equivalent of media specific commands in the cards protocol (e.g., secure read in the SD card) that the host wishes to send to card, it can also occur when then card is attached directly to a host. In more complex cases, there may be several intermediate protocols, in which case several layers of embeddings could be used, as will be seen in the second example.

As one particular example of when there need not be a separate card reader, there exist cards with two sets of contacts, one for use with an USB port and another for a standard set (MMC, SD, CF, etc.) of card contacts. (Examples of such dual contact cards are described in U.S. patent application Ser. No. 29/203,693, U.S. Ser. No. 10/826,801, and U.S. Ser. No. 10/826,796, all filed Apr. 16, 2004, all of which are hereby incorporated by reference.) With the “normal” card contacts, the card can communicate with a first host in the card specific protocol allowing the media specific commands. With the second set of contacts (here, USB), the cards may communicate with another host, such as a PC, in another differing protocol that lacks equivalents of the media specific commands. In this case, the second host and the other protocol by embedding the media specific commands according to the present invention: for example, using the USB contacts the card can be connected directly to a PC at an USB port through which they communicate in the SCSI protocol, with any SD specific commands embedded in the SCSI protocol as described above.

As noted, in a set of embodiments of particular interest the host and the card communicate in the protocol of the card, but a host application may want to exchange commands and data with an application on the card in a layer of which the “usual” memory functions of the card are unaware. For example, with an SD memory card can be a device application layer partition hidden from the SD specific firmware layer. The host and card will communicate using the standard SD protocol, but the hidden device application can communicate with the corresponding host application by embedding application specific commands within the SD protocol. The first exemplary embodiment is of this nature.

The exemplary embodiments embed the media specific (or application specific) commands within a write command. A write command is used as the examples embed the command within the data portion of the intermediate protocol and a write command inherently has a data portion. More generally, not just a write command but any command that accepts a data portion may similarly be utilized. Since a write is a basic instruction in a protocol to transfer data, the exemplary embodiments below will continue to be described in terms of a write. Additionally, although in all of the examples the media or application specific commands are embedded at the beginning of the data portion for simplicity, more generally they may be placed elsewhere in the data portion and be identified by the signature. (As noted above, more generally, the signature, the application command, or both may also be embedded in the command portion of the transmission protocol in protocols, such as the SCSI protocol, that have sufficient room in their command portion.)

The problem with which the invention is concerned can be presented at a more abstract level. Consider where the host application needs to communicate with the device application in a protocol having a set of commands (α, β, γ, . . . ), but somewhere in the communication path another protocol having a set of commands (A, B, . . . ) needs to be used. In the example of the Background, (α, β, γ, . . . ) would be the SD protocol and intermediate command set (A, B, . . . ) would be the SCSI protocol. In the discussion below, (α, β, γ, . . . ) would be the command set for the particular application (such as the hidden partition) and (A, B, . . . ) would instead be the card command set. As long as there is a correspondence A [symbol] α, B [symbol] β, and so on, there is no problem. The difficulty arises when there is a media or application specific command γ, say a secure read in the SD protocol, with no equivalent in the intermediate protocol: ? [symbol] γ. Under the prior art, a new command equivalent to γ, say C [symbol] γ, would need to be introduced for each such γ. Instead, according to the present invention, rather than introduce a new command, the media specific command is embedded in an existing command in the intermediate protocol, A(γ) [symbol] γ, where A(γ) represents a write, say, command with γ embedded.

In a generalization, a command (call it F) is introduced into (α, β, γ, . . . ) protocol to open a pipe for the host and device sides of the application to communicate. Once the pipe is opened, the media or application specific commands can then be sent. This can be represented as A[F(γ)] [symbol] γ. This technique will be developed in the first example. This allows for handling command failures and other subtleties. The problem with a command failure is that the intermediate protocol has no knowledge of the nature of the embedded command since, as far as the intermediate protocol knows, it is sending a simple write command. If the embedded command is a read, for example, the PC will not know what has occurred in the event that the read fails. In the intermediate protocol, it will be seen as a write fail and not be interpreted as a failure of the embedded read; consequently, the host will not understand the appropriate recovery steps to execute. By opening a pipe between the host and card sides of an application, such difficulties can more easily be tracked and dealt with.

### FIRST EXEMPLARY EMBODIMENT

The first exemplary embodiment is implemented at the file level on the host side and will be used to illustrate various aspects of the present invention; on the card side, the implementation is largely the same whether host side is implemented at the file or device driver level. When reference is made to a particular application for this embodiment, it will be given in the context of a hidden partition on the memory card, where the memory is divided into publicly accessible portion and a private, or “hidden”, portion. Such an arrangement is described in U.S. provisional patent application 60/638,804, filed Dec. 21, 2004, which is hereby incorporated by reference, although most the details are not so limited. The host side portion, in particular, the device driver, will be described first, followed by card details. Other examples of the use of a hidden partition are described in the following patent applications, all of which are hereby incorporated by reference: Ser. No. 11/067,298, filed Feb. 25, 2005; Ser. No. 10/703,471, filed Nov. 10, 2003; Ser. No. 10/899,260, filed Jul. 26, 2004; and Ser. No. 11/050,013, file Feb. 2, 2005.

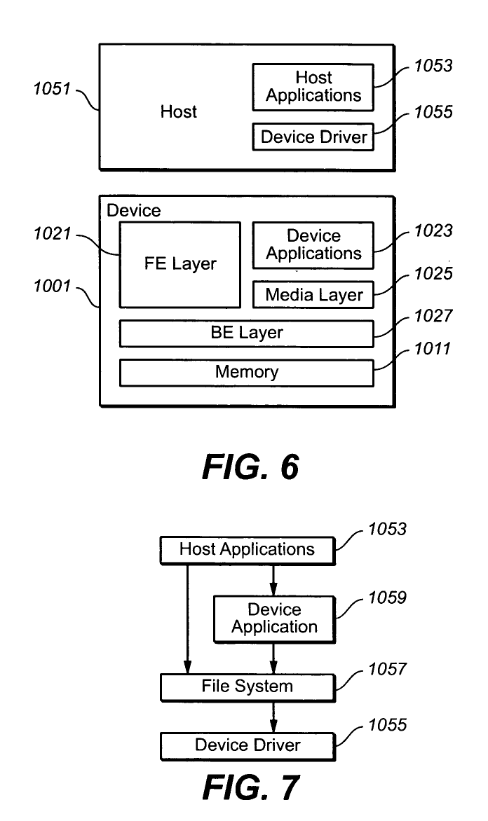

FIG. 6 is a schematic block diagram showing an exemplary structure on the device side. On the card 1001 side, the Device Application or Applications 1023 each provide a gateway, or “pipe”, for the Host Application or Applications 1053 on the host side 1051 to a non standard, for this specific form factor, card feature, here the hidden partition. The host side layer's are described more in FIG. 7 below. On the card side, a device application 1023 supplies partition access (Read & Write), status, and other device application information. The device application 1023 can communicate with the host application 1053 via the exemplary protocol described in the following and use the card's systems and memory resources through the Media layer 1025. The memory itself is indicated at Memory 1011 and will commonly be a Flash memory of the NOR or NAND variety, although other non-volatile memories, including those described in U.S. patent application Ser. No. 10/841,379, May 7, 2004, which is hereby incorporated by reference. FE (Front End) Layer 1021 is the firmware layer that handles the commands (in the card type interface such as the CF, SD, MMC, etc. protocol) from the host side. BE (“Back End”) Layer 1027 is the firmware layer that handles the management of Memory 1011, including reads and writes to the memory. The Media Layer 1025 connects the Device Application firmware 1023 with the BE Layer 1027 and will also interface the application firmware with the RAM resources of the controller, which is not specifically shown in this view.

When an instruction is sent from the host 1051, it is initially received on the device 1001 at the front end (FE) layer 1021. The command will be in the intermediate protocol used between the host and device, for example the SD protocol. When the command arrives at the FE layer 1021, it is checked for a command pass through signature: if no signature is found, the instruction is treated as a standard instruction from the intermediate protocol and can access the memory or otherwise be executed in the standard manner; if the signature is found, the embedded application specific command is extracted and passed on to appropriate device application 1023 for execution. When implemented (on the host side) at the device driver level, as in the second exemplary embodiment below, the command will be addressed to a specific logical address, while when implanted on the file level, as in both this example and the third example below, the command can be to any logical address; as seen from the device side, both implementations are largely the same.

Once the signature is found and the embedded command is extracted, the hidden partition (in this example) will be made available to a host application 1053 via the corresponding device application 1023 resident on the card 1001. The host and device applications will communicate using a protocol that will cover the reads and writes between the host and card sides, as well as reporting on the partition status. In this exemplary embodiment, the device controls the rights to the application. The rights (read, write) are given when the device confirms the host application's credentials and, upon approval, the device application will grant read and write privileges to the partition through the host/device protocol. Once the host application has been validated, then the assumption is that the device is operating within a trusted environment.

As noted, the first exemplary embodiment will be implemented at the file level, with the embedded commands placed in the first data sector of the write file. The implementation does not rely upon reference to any specific logical address, but rather upon checking the first data sector for a particular pattern or signature. The files in the partition are managed by the host, meaning that, in the hidden partition example, the host application is the owner of the file system in the hidden partition. Once the host application obtains rights to the application, it has full control over the content.

A host application 1053 will implement a file system layer since the FAT of the hidden partition often cannot be read due to access privilege problems with the operating system (OS). As with any access to the hidden partition, the FAT will be available only after the pipe to the application is open. (The command transfer by the host application will be defined and explained below.) The host application will reside on the card's non-hidden, or public, partition, seen by the OS at the mass-storage device or removable drive level. Several such host applications can reside in this area and the user will know which one to execute, which will be executed on the host side.

The host side software layers are described in more detail with respect to FIG. 7. The device driver 1055 has two roles. It functions as bus driver and performs 10 operations for the standard client applications supported by the (intermediate) protocol and the File System 1057. In addition, it also implements the application and the device or application specific protocol. The standard IO API and implementation can be common to all of a card family, for example the standard SD card operations. The application or device specific API and implementation are protocol specific by nature. FIG. 7 shows an example of a hierarchical structure that enables code sharing for the common part and simple portability between different applications specific protocols.

In addition to the host application layer 1053 and file system layer 1057, the host structure now also incorporates a layer 1059 specific to the device applications. For “standard” device operations, not incorporating the application specific operations, the layer 1059 is not used and the layers 1053, 1057, and 1055 will largely operate as in the prior art. When an application specific instruction is to be used, the device application layer 1059 will be interposed between the file system 1057 and the host layer 1053 in order to format and embed the application specific commands.

The device driver 1055 can include interface and pipe sub-layers to provide common functionality and can be used with minimal changes with all application specific protocols. The host's application should match the protocol layer according to the particular application. The interface sub-layer will expose a standard set of device functions. For example, these would include: hardware initialization and configuration; drive open and close routines; read and write operations; and erase. It will also include a function to the appropriate communication method and initialize the pipe accordingly.

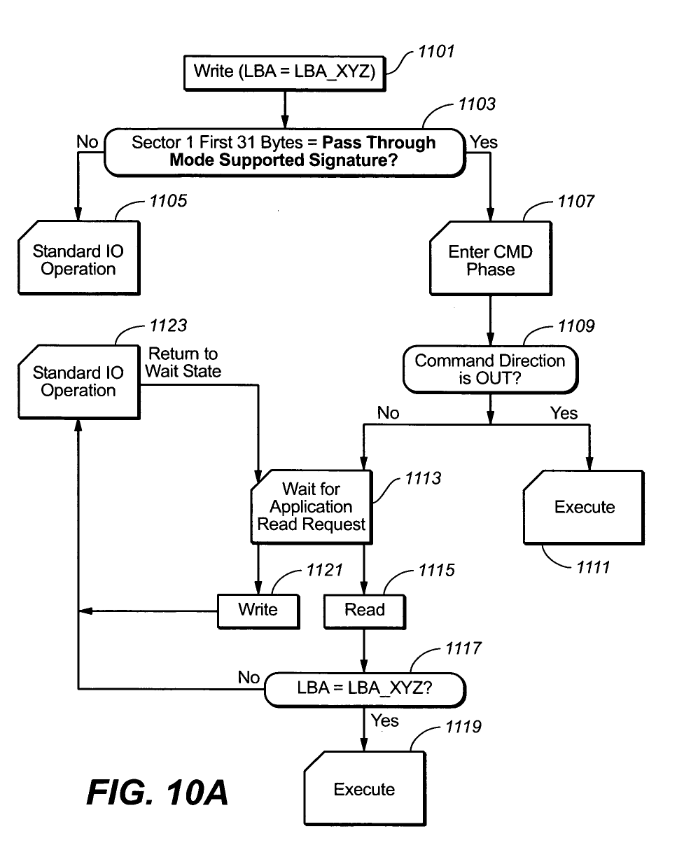

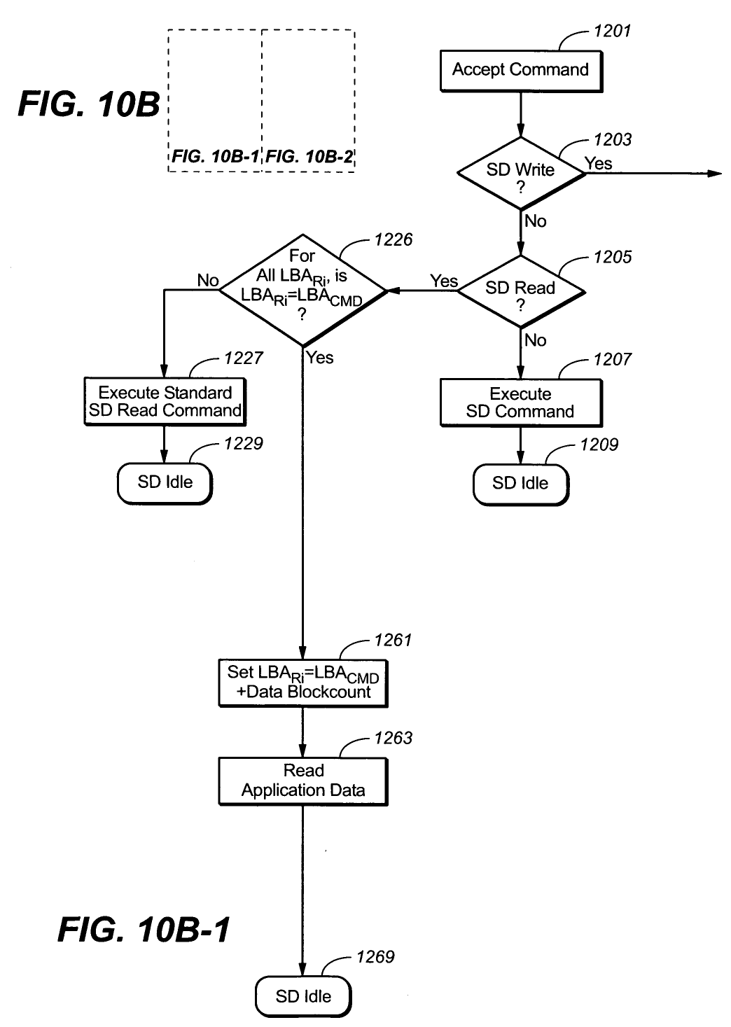

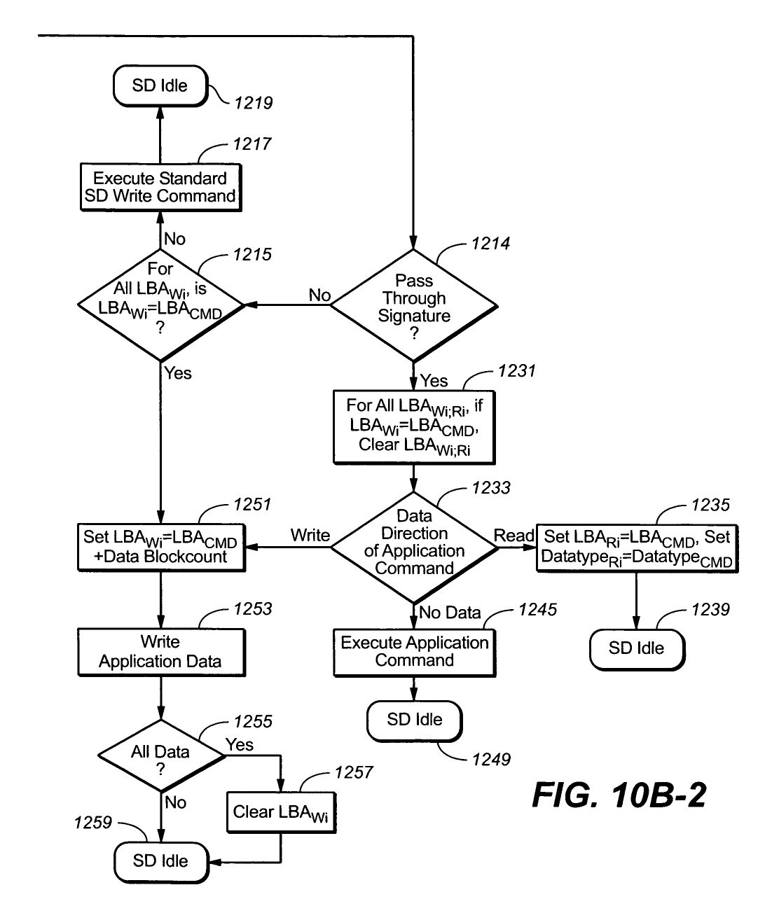

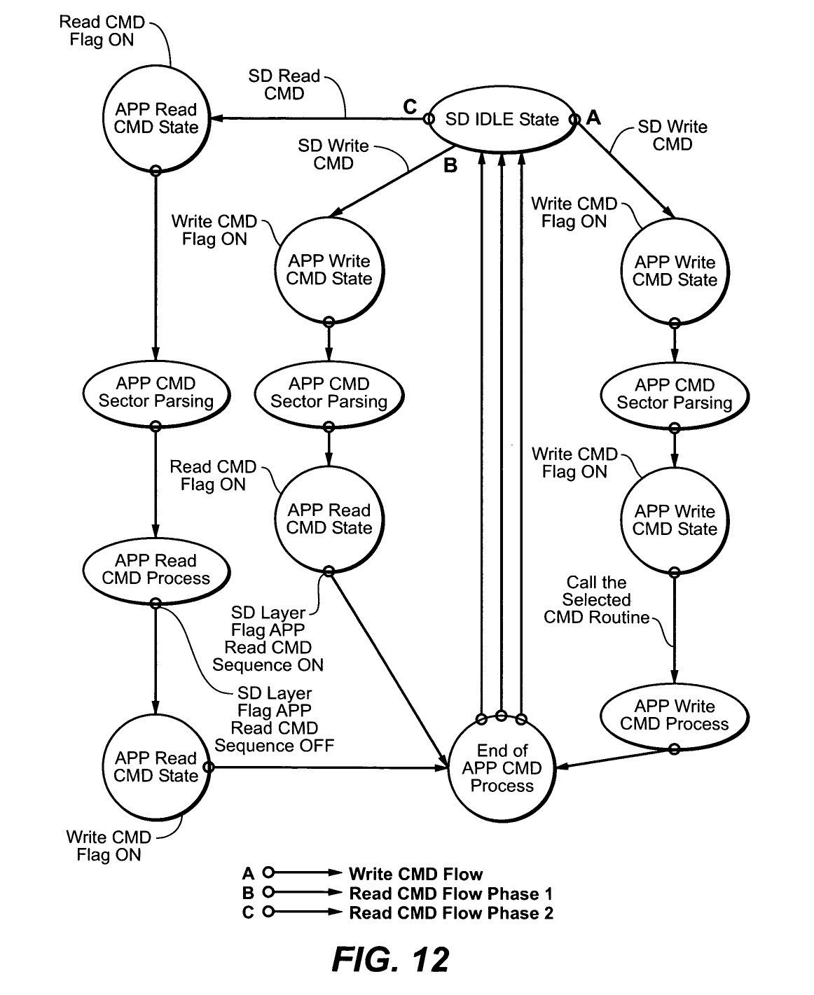

When an instruction, such as 510 of FIG. 5, is transmitted, in some cases the operating system (OS) may split it up into several pieces, possibly even interposing pieces of other instructions. In these cases, the file system 1057 and device driver 1055 can break up the instruction 510 so that the command portion 511 is attached to anywhere from none to all of the data portion 513, with the rest of the data portion following in one or more subsequent transfers. In these cases, the subsequent transfers for the remaining portion of the data will lack the signature portion of section 513a and appear as a standard command. Such a division could also occur for data being transferred from the card to the host in a read operation. In the case where is either known that the OS will not split up an instruction, or the OS can be controlled enough so that it can be instructed not to do so, the procedure can be simplified. This is discussed first with respect to the flow of FIG. 10A and the corresponding state machine diagram of FIG. 12. The more general case will subsequently be discussed with respect to FIG. 10B. Additionally, for simplicity of discussion, the discussion with respect to FIG. 10A will largely be based on the case of only a single application, although there will typically be a number of different such applications active. The more generally case of FIG. 10B will make this more explicit.

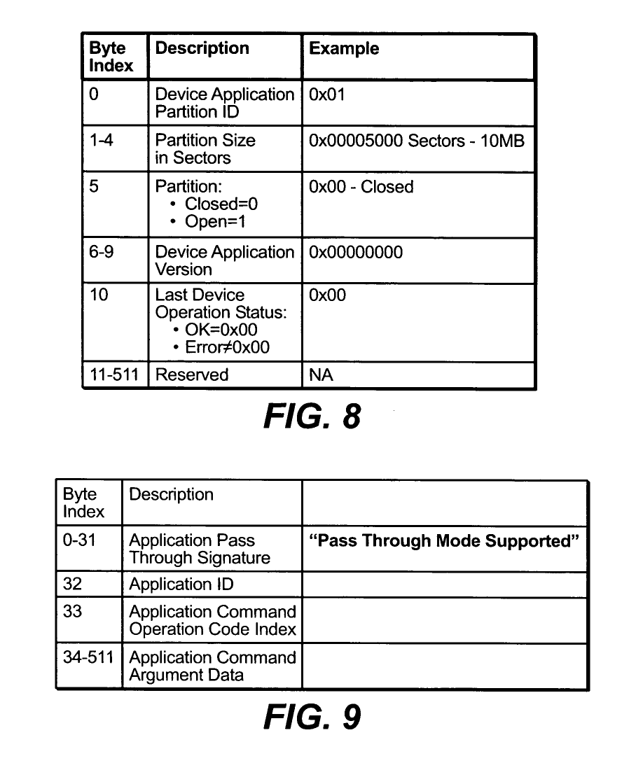

For the first exemplary embodiment, a simple hidden partition protocol is used for demonstration. The memory 1011 is divided into two partitions. The first partition is the product standard partition. A standard host is aware only of this partition. The second partition is the hidden partition that is accessible only through application specific commands. A standard host is unaware of this partition and has no way to access it. The hidden partition protocol of the example defines five functions through which the device and application communicate:
1. Open Hidden Partition: Used to authenticate the user and enable read and write operations.
2. Close Hidden Partition: Disable read and write operations.
3. Get Hidden Partition Status: Returns the data shown in FIG. 8.
4. Hidden Partition Read: If the partition is open, reads from the hidden partition. If it is closed, returns an error.
5. Hidden Partition Write: If the partition is open, writes to the hidden partition. If it is closed, returns an error.
   The protocol layer provides the additional API that's required to implement the security protocol. In the specific example of Hidden Partition the protocol requires three services in addition to read and write: Open Partition Close Partition Get Partition Status. These commands are shown below in Table 1, where along with FIG. 8, they are discussed further.

The pipe sub-layer is responsible for the communication with the card according to media command pass through principles. As previously described, the main idea in the media command pass through protocol is that special commands (commands that are not part of the standard product specification) are embedded within standard Read and Write operations. Embedding the commands in standard Read and Write operations enables to work with standard hosts and drivers.

In the exemplary embodiments, all commands will be initiated by sending a write command to a certain LBA of the media card. Application specific write commands will include multiple sector transfer where the first sector holds the command's arguments and the rest of the data blocks hold the relevant data if any. Read commands will be executed in two parts:
1. Initiating the read command by first sending a write command to a chosen LBA with the appropriate data describing the nature of the read command.
2. After the write command sets the card application on the correct state of transfer, the read command to the chosen LBA from the write command will be sent to do the actual data transfer from the card to the host.

All commands first send a write command with the sector format shown in FIG. 9. When the host application decides to send a write command, the first sector transferred will have the above format. The next data blocks sent from the host will have the actual data for the card. If the host application chooses to initiate a read command then it first sends a write command to the chosen LBA (LBA=LBA_XYZ) with the above single sector format and then a read to the same LBA. This is shown in the flowcharts of FIGS. 10A and 10B, discussed further below.

A number of possible implementations are possible for the media command pass protocol. The example of this section uses a file system, for example Windows file system operations. The example of the next section communicates directly with the device at the device driver level and does not have the file system overhead. Another implementation can be for a pocket PC (PPC). In this last case, read and write operations can directly access the PPC storage driver. Since there is no standard storage device driver for pocket PC devices at this point, there is no guarantee this method will work on all PPC devices. The client application vendor should test it with the set of PPC devices it intends to work with.

Returning the file system implementation of the present example, the pipe sub-layer initiates read and write operations to the Command Pass Through LBA by reading and writing from/to the same file location, indicated as LBA_XYZ in FIG. 10A for the case where the OS will transfer the entire instruction in a single transfer. This need not be a predetermined address, as in the example of the next section, but any logical block address. For this example, the implementation uses Windows' standard file system API—CreateFile, ReadFile, WriteFile and SetFilePointer. The implementation sets can be broke into four or five parts: the pre-requirements; the establishment of the communication pipe; the verification of the file length; the applications write command; and, if data is to be read or other information returned to the host, the read command.

In a file level implementation, the file system is used to unknowingly transmit the embedded, application specific commands. Since the actual, embedded command may be of a different nature from what the command in the intermediate protocol that file system thinks that it is sending, a conflict can arise if appropriate steps are not taken. For instance, if a error arises, error recovery can be complicated as the file system will see this as an error in the carrying command (a write) in the intermediate protocol, when the actual error may be with the embedded command (for example a read). Similarly, a dissonance can result if the file system employs caching.

Another problem can result from file segmentation: as the exemplary implementation relies upon reading and writing from/to the same file location (LBA_XYZ of FIG. 10A), the entire file should be stored to a sequential group of sectors in the memory. If the data to be stored starting at LBA_XYZ is larger than the available segment, the file system will break it apart. Consequently, the maximum data length for the application specific commands should be no larger than the smallest OS file allocation unit (cluster), so that the used logical address (LBA_XYZ) is associated with a logical block address having sufficient space.

In the Windows example, the pre-requirements for the file system implementation require a standard file that contains at least 128 sequential sectors. To ensure the existence of such file, it is created on formatted drive. Therefore, if the host application vendor chooses this method, they should deploy the communication file with the application. In this example, the design assumes that a file named “FilePipe” (with certain attributes specified below) exists in the device user area. If such file does not exist the driver will try to create it. If it fails, the application can ask the user to format the drive and re-install the application on formatted drive.

To establish the communication pipe, the device driver 1055 preferably opens the communication file with the following attributes:
Not shared
No Buffering
Hidden
   The Not shared status ensures that only the host application has access to the file in order to prevent other applications from accessing the Command Pass Through LBA. The No Buffering status instructs the system to open the file with no intermediate buffering or caching. Thus, any write or read to/from this file results read/write commands to/from the card rather than a cached version. (In some cases, to ensure that the file will be flushed to the card, it may necessary to set both a “no buffering” flag and a “write through” flag.) Since the actual application or media specific commands are embedded within commands of another protocol, when there is, say, a write error, the host interprets this as an error with the write command in the intermediate protocol rather than an error with the embedded command. The No Buffering status keeps the data transfer tied up to the intended, embedded command. The Hidden status implies that the end user sees this as a system file.

The next implementation step is to verify that the file contains at least 128 sectors that are sequential.

For the application's write command, a secure write in the hidden partition example, the write buffer is prepared along the lines described above. The file pointer is then reset to ensure that read and write operations are for the same LBA (=LBA_XYZ). The buffer is then sent to the device by calling the “WriteFile” command with the “FilePipe” name.

For the application's read command, a secure read in the hidden partition example, the file pointer is first reset, followed by performing a “WriteFile” command to send the command buffer. The file pointer is then reset again to ensure that the Write and Read operations are done on the same LBA. The “ReadFile” is then performed to obtain the secured data from the device.

Returning to the card side, the Device Application 1023 will manage the hidden partition (in this example), allowing reads and writes pending on host application validation. Resource and memory access are through the Media Layer 1025 for the hidden partition phase. The Media Layer 1025 will direct all of the device application data transfer to the hidden partition on the memory 1011.

As described, the Device Application 1023 receives its specific commands from Host Application 1053 through the regular card protocol read/write commands. For example, taking the SD card protocol as the exemplary embodiment, each command index and arguments are passed on in a command sector via SD write command. When a read command is expected from the device application, then first the host application will send a write command (through SD write command) followed by the actual read command (SD read command). The read command context is saved, for example in RAM space dedicated to the device application, during the write command that passed the command sector. When the read command follows, the device application will then load the saved read context and transfer the requested data. The saved read context will remain as is until it is superceded by another read context. This will enable the host to perform read retries without sending another write command+command sector.

Because most protocol commands act as read/write commands, it is possible to transfer new commands that are application specific through reading and writing to certain LBAs. In the exemplary embodiment, all commands will be initiated by sending a write command to a certain LBA of the media card. Application specific write commands will include multiple sector transfers, where the first sector holds the command's arguments and the rest of the data blocks hold the relevant data, if any.

As noted, read commands are executed in two parts:
1. Initiating the read command by first sending a write command to the chosen LBA, with the appropriate data describing the nature of the read command.
2. After the write command sets the card application on the correct state of transfer, the read command to the chosen LBA from the write command will be sent to do the actual data transfer from the card to the host

Returning to FIG. 9, all commands must first send a write command, where FIG. 9 shows an exemplary format for the argument data sector here. As shown in FIG. 9, bytes 0-31 hold the application pass through signature (e.g., “Pass Through Mode Supported”), byte 32 the application's ID, byte 33 the application command operation code index for the embedded command, and with the application command argument data filling out the rest of the sector.

When Host Application 1053 decides to send a write command in this embodiment, the first sector transferred will have the format of FIG. 9. The next data blocks sent from the host 1051 will have the embedded command's actual data for the card. If the host application chooses to initiate a read command, then it first sends a write command to the chosen LBA with the above single sector format and then a read to the same LBA to effect the read.

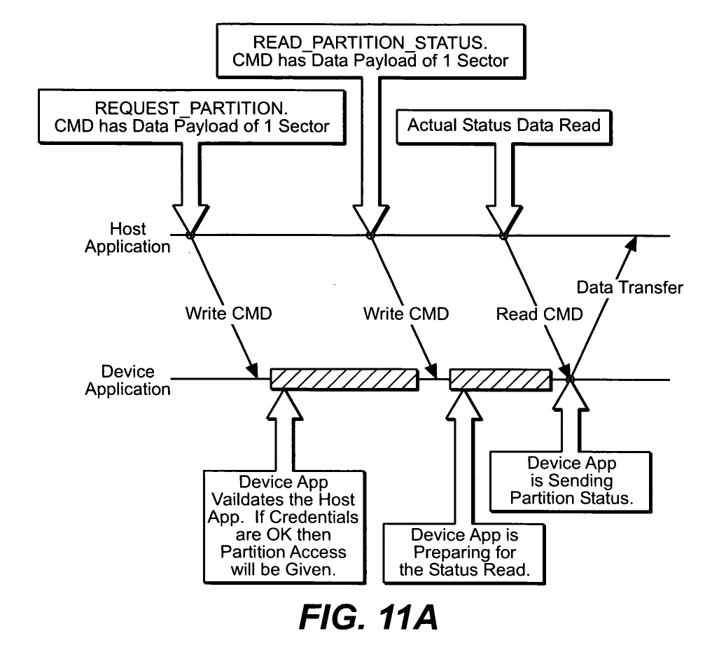

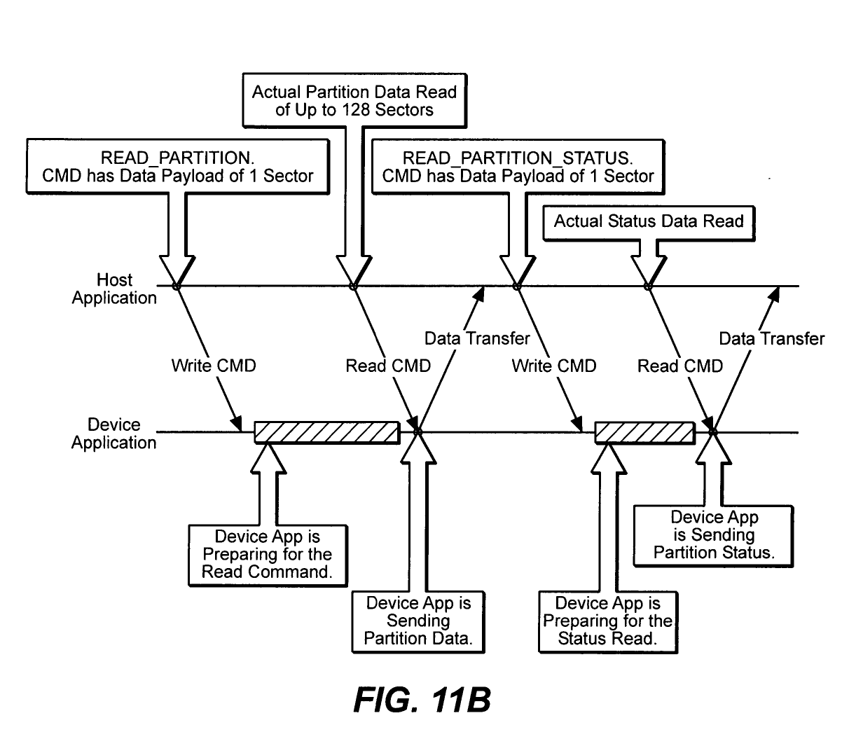

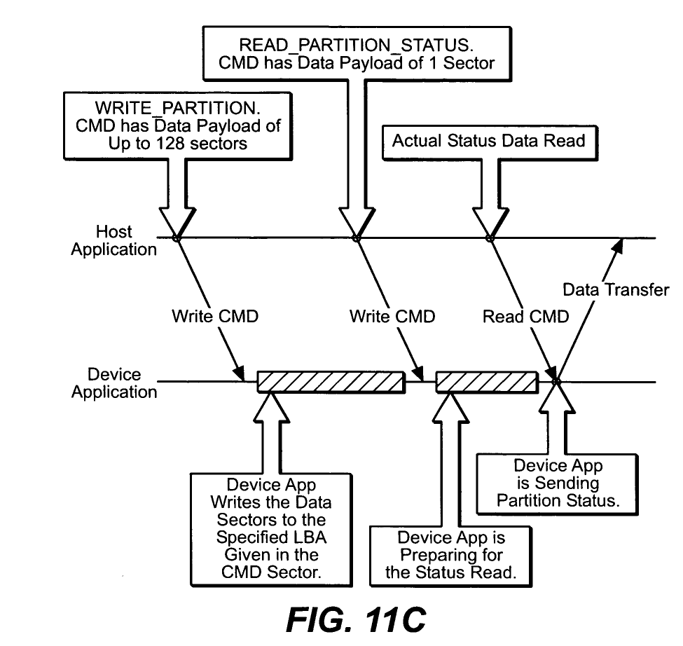

The host application 1053 is responsible on initiating the described commands according to the communication flow as seen from the device, shown in FIG. 10A. To do this, the host application controls the target LBA for the card protocol's read and write operations that will carry the embedded command as described above. Although described for only a single command at a single LBA, the process shown in FIG. 10A (and FIGS. 11A-C, FIG. 12, and so on) may be occurring for multiple LBAs as they can all rely upon the pass through mode signature. (This case is described below in more detail with respect to FIG. 10B, where the various LBAs are indicated a subscript, LBAᵢ.) The particular LBA is only relied upon by the device's state machine (as discussed with respect to FIG. 12 below), as the device is able to concurrently deal with multiple files.

The process begins at step 1101 when a write to the chosen LBA is received, here taken as LBA=LBA_XYZ. The signature is then checked (1103) to see whether it is the application pass through signature: if not, the card engages in standard IO operations (1105); if so, it enters the CMD pass through mode. Step 1109 determines whether the command direction (as seen from the device) is OUT or not. If the direction is OUT (e.g., a write to the device's memory), the command is executed (1111).

If the command direction is not out, the memory device waits for the second command of the read pair, an application read request, at 1113. If instead a write arrives (1121), it goes to standard IO operation (1123) before returning the wait state (1113). If a read command is received, the LBA is checked (1117) and if it is to the chosen LBA, it is the second command of the read pair and the read is executed (1119); if the LBA does not match, it instead goes to 1123.

There is more than one possible implementation manner and implementation details vary according to the target platform. One common manner, which applies to Windows NT based desktops and described above for the host side, is to use a virtual file and standard Windows File System API. Another way is to directly initiate the card protocol's (e.g. SD) Read and Write operations using Windows SCSI Pass Through API, as described in the next example. This manner applies Windows NT based desktops also, but it requires administration rights as discussed above for the implementation at the card driver level.

As for the command interface between the card's firmware and the application's firmware, in a first step, the card-FW receives an application specific command. After verifying the Card Pass Through Mode Supported signature, the card's FE layer 1021, will pars the argument data sector that came with the write command to a chosen LBA for the Application ID and Command OP-Code. The Application Specific Command Interpreter will call the application interface routines with a pointer to the host data buffer. In a second step, when starting an application specific command sequence, the application FW must set it's own state machine to handle the application command sequence and also set a flag to indicate that the next read/write command to a chosen LBA is intended for application FW. Each time a read command is sent to the card (to the chosen LBA), the card's FW will first check this flag to distinguish this application specific read command from a regular read command to this LBA.

An example of a protocol for the hidden partition application will now be described. FIGS. 11A-C illustrate some of the same processes as for FIG. 10A, but in terms of the activity on the system bus between the host and the device. The process for an authentication and secure partition FAT read is shown in FIG. 11A. First, the host sends Username+Password to the card for authentication. Upon authentication, the card will enable the application to read the FAT from the secure and hidden partition. The partition stays open until the host ends the session or the device goes through a power cycle. As long as the partition is open, reads and writes to the hidden partition by the host application are allowed.

FIG. 11B illustrates a host read of a file in the secure partition. As described above, the application specific read command occurs within two card protocol commands: a write command that specifies the nature of the read command and arguments and then the actual read command.

FIG. 11C illustrates a host write to the hidden partition. Passing authentication, the host has access to the partition's FAT and now has the right to transfer a new file to the host. The host sends a write command to the secure partition with a write start address and sector count.

FIG. 8 shows the embodiment of device application status, introduced above, along with exemplary values for the hidden partition example. As several different partitions may be allowed, byte 1 in the device applications partition ID, given as “1” in the example. The next four bytes give the partition size, here shown as ten megabytes worth of sectors. Byte 5 indicates if the partition is currently open or not and the next four bytes are given to indicating the version of the device application. Byte 10 provides operation status. Bytes 10-511 are padded out with zeros to form a sector. In a variation, byte 11 may be used to record the number of sectors written in the last transaction.

Table 1 describes an example of application protocol commands that are sent to the device application for the hidden partition example. The CMD Index is placed in byte 33 of the command sector, and Command Arguments are placed from byte 34 and on in the specified order written in the table.

TABLE 1

| CMD | | | Number |
|---|---|---|---|
| Index | CMD Name | CMD Arguments | of bytes |
| 1. | OPEN_PARTITION | User Name Length | 1 |
| | | In Bytes | |
| | | User Name | Specified |
| | | | in first |
| | | | argument. |
| | | User Password | 1 |
| | | Length In Bytes | |
| | | User Password | Specified |
| | | | in 3^{rd} |
| | | | argument. |
| 2. | CLOSE_PARTITION | User Name Length | 1 |
| | | In Bytes | |
| | | User Name | Specified |
| | | | in first |
| | | | argument. |
| | | User Password | 1 |
| | | Length In Bytes | |
| | | User Password | Specified |
| | | | in 3^{rd} |
| | | | argument. |
| 3. | READ_PARTITION | LBA number | 4 |
| | | Sector Count to read | 4 |
| 4. | WRITE_PARTITION | LBA number | 4 |
| | | Sector Count to | 4 |
| | | Write | |
| 5. | READ_PARTITION_STATUS | Partition ID | 1 |

As the embedded hidden partition commands are transferred through the device's write protocol, such as the SD protocol, the partition's command interpreter will be called by the, say, SD command interpreter after establishing that the write or read commands are actually meant for the partition's device application and not for the SD regular operations. The command interpreter will call the appropriate routines after parsing the command sector. In a specific embodiment, the application's command can have as a first argument a parameter indicating whether the MD command is a Read command or Write command. A second parameter can pass a pointer to a location in the allocated RAM where the command sector is placed. The pointer will point to byte 33, Command Operation Code Index, since the relevant information for the partition's device application begins at this point of the sector. The buffer size that is pointed to by this second parameter can be specified in a third parameter.

As already noted, write commands for the device application are simple because they are executed right after the command sector is parsed, in the same sequence as those of the card protocol. For example, in the SD case:
1. SD-write command (1 or more sectors) is received—the first sector is always the command sector in the exemplary embodiment.
2. The card-layer parses the first 32 bytes of the first sector and recognizes the command sector's signature. The Device Application command parser (interpreter) is called with a pointer to the command sector.
3. The command interpreter, after it is done identifying the embedded application command, calls the corresponding routine that will execute the embedded command and begin the application's command process.
4. The command process is for the hidden partition's application is done and a status is returned to the card-layer, where the sequence is going to end as an SD-write command process would. The SD card goes to IDLE state.

Also as already noted, read commands in the hidden partition's application protocol are a two-step process that is comprised (again in an SD embodiment) from an SD-write command followed by an SD-read command. The first step is the SD-write command:
1. SD-write command with one data block (512 bytes) sent by the host—the first sector is always the command sector in the exemplary embodiment.
2. The card-layer parses the first 32 bytes of the first sector and recognizes the command sector's signature. The Device Application's command parser (interpreter) is called with a pointer to the command sector.
3. The command interpreter, after it is done identifying the embedded application command, identifies the embedded read command that is about to be executed (in the next SD-read command), saves this command identifier. Then the command interpreter sets the card-layer read command flag
4. The application's command process is done and a status is returned to the card-layer where the sequence is going to end as an SD-write command process would end. The SD card goes to IDLE state.
   The second step is an SD-read command:
1. SD read command.
2. The SD card-layer checks the application card-layer read command flag and finds that it is set—instead of calling a regular SD read command it calls the device application command interpreter with a read command indication.
3. The device application command interpreter identifies the partition read command flag and recalls the partition read command identifier that was saved in the previous write command. The identifier directs to the corresponding partition read routine and initiates the partition read sequence.
4. The partition read sequence is done and a return status is passed to the card layer.
5. The card layer ends the SD-read process and the card enters IDLE state.

The read and write processes are illustrated by the card side application's commands state machine, shown in FIG. 12 for an SD-based embodiment. Since these embedded commands are passed by SD write commands, and when a hidden partition Read command needs to be executed the host cannot pass the command sector on an SD read command, the Device Application's (1023) command interpreter needs to maintain a state machine which will manage and know which read command is being executed by the Host Application 1053. In this figure, the bubbles refer to the device specific application commands that are executed at the device application layer (1023, FIG. 6), while the attached comments refer to the commands as seen at the FE layer (1021, FIG. 6) that are in the intermediate (here SD) protocol. The right side (the A path) of FIG. 12 is the process for a write process, where any process where either data is transferred to the device or no data is transferred will follow a similar flow. The left side of FIG. 12 corresponds to a read or other process where data is transferred from the device to the host. The read flow consists of the B path for the first command of the pair needed for a read and the C path for the second command of the pair.

Both the write flow and the read flow begin in the same way, receiving an SD write command from which, after the signature is detected, the embedded command is parsed. For the write flow, the write flag stays on and the write process is executed. For the first phase of the read flow, however, the read flag will be set. This Card Layer (SD) Read Process Flag is set by the Device Application (1023) when a read process from the host is detected. The flag indicates to the card layer that the next read command from the host (on the SD bus) is not a regular card read and should be directed to the Device Application (1023) for handling. This occurs in phase 2 of the read flow, in which, in response to the second command of the pair, the data is transferred from the device. The flag gets reset when the card layer initializes.

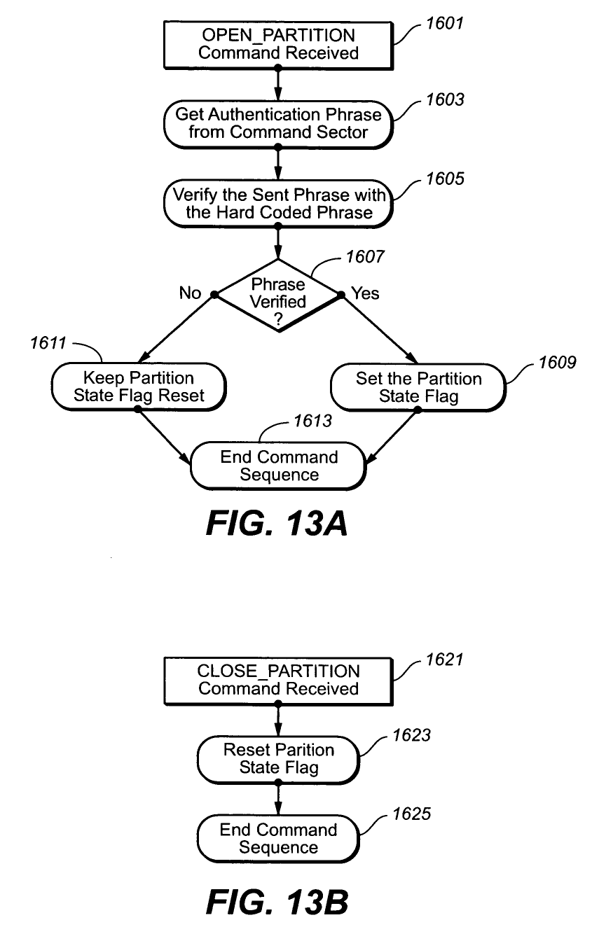

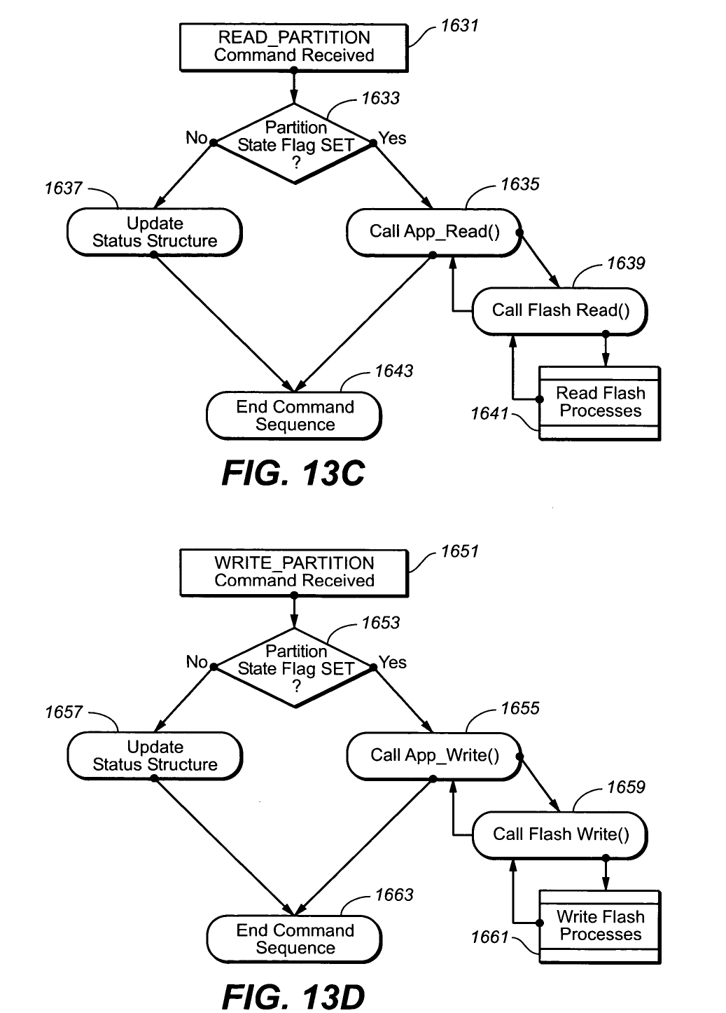

Referring to the commands listed in Table 1, the OPEN_PARTITION command (OP-Code 0x01) accepts a username and password and verifies them. If they match to the Device Application's stored name & password then the partition is opened for host access (Read, Write). At this point, there will be one authentication phrase that will be sent and verified against a phrase in the Device Application's code. This process is shown in FIG. 13A. The partition will stay open until the CLOSE_PARTITION closes it or until the next power cycle.

The use of the CLOSE_PARTITION command (OP-Code 0x02) is intended to close the application working session and not leave the partition open. An embodiment is shown in FIG. 13B.

The use of the READ_PARTITION command (OP-Code 0x03) is shown in FIG. 13C. If the partition is open (the yes path from 1633 to 1635), then this command will enable the host application to read data stored in the partition (1639, 1641). In the exemplary embodiment, this routine will call a “FlashRead” API routine, which will direct the data transfer to the hidden partition space.

The WRITE_PARTITION command (OP-Code 0x04) directs data from the host to the hidden partition on the card. As shown in FIG. 13D, this command will be executed by the device application only if the Partition Flag is SET (1653). This routine will call a “FlashWrite” (1659, 1661) API routine, which will direct the data transfer to the hidden partition space.

The READ_PARTITION_STATUS command (OP-Code 0x05) supplies the information shown in FIG. 8. This is an application read command with the structure discussed above with respect to FIG. 8. When the command comes in, the routine will gather all the information and place it in the structure above and send it to the host.

As noted above, some operating systems will at times split up an instruction so that not all of the data portion will be attached to its corresponding command portion. In this case, part of the data of a write instruction will show up at the card without the card pass through signature; consequently, what appears to be a standard command in the transmission protocol with no signature attached could actually be the rest of an application specific command. As a concrete example, consider the case of instruction 510 of FIG. 5 that has, say, a data portion 513 of ten blocks. In transmitting this instruction to the card, the host's operating system might send only the first five blocks of the data portion attached to the instruction, with the remaining five blocks being transmitted later. When this last set of data blocks is sent, it will lack the initial data block 513a, which contains the signature and actual command for the application protocol, and appear as part of a standard command from the transmission protocol. Such a segmentation may also occur when the embedded, application specific command is a read-type command, so that the data is sent from the card to the host in portions. FIG. 10B extends the flow of FIG. 10A to account for such segmentation in both application specific read and write commands by replacing the single logical block address LBA=LBA_XYZ with the logical addresses LBA_{Ri} and LBA_{Wi} for read and write processes. By defining an LBA_{Ri} reads as well as an LBA_{Wi} for writes, the device can deal with breaks in the transfer of application data in either direction. The subscript i is to allow for the concurrent implementation of multiple application specific commands from multiple applications and multi-user host devices.

The process of FIG. 10B is again based on the example of an SD card using the SD protocol as the transmission protocol and begins with device in the SD idle state and accepting a command at 1201. It then determines whether the received instruction is an SD write (1203) and, if not, whether it is an SD read (1205). If it is neither an SD write nor an SD read, the SD command is executed (1207) and the device returns to the idle state (1209).

If the received instruction is an SD write at step 1203, it is then checked for the pass through signature (1214). If the signature is found at 1214, this indicates the beginning of a new embedded command, which can then be extracted. At 1231, for all of the read and write logical block address LBA_{Ri;Wi}, if the logical block address for the incoming command, LBA_{CMD}, is the same as a logical block address assigned to a current writing process, LBA_{CMD}=LBA_{Wi}, then the corresponding LBA_{Ri;Wi} are cleared. Normally, the assigned LBA_{CMD} should be unused, but in case it has already been assigned to another process, this will abort it and clear the address.

The data direction of the application specific command is then determined (1233). If involves no data transfer, the application-specific-command is then executed (1245) and the device returns to the idle state (1249).

If the application's command is a write, the corresponding logical address is set as LBA_{Wi}=LBA_{CMD}+ data blockcount (1251) and application data is written (1253). As discussed above, the host's OS may split the instruction up so that the command is not accompanied by all of corresponding data. When the embedded command is extracted and parsed, the card will know how many blocks of data the command should include. At 1255, it checks to see whether all of the data was included and written. If so, LBA_{Wi} can be cleared (1257); otherwise, it is not cleared as the rest of the data will, unless interrupted by an error or shutdown, eventually follow and will look like a standard SD write command to a consecutive (relative to this command) card address which is the address calculated above. The device will then return to the idle state (1259) to await further commands.

Returning to 1231, if the application command is a read, then the device sets LBA_{Ri,}=LBA_{CMD} and sets datatype_{Ri}=datatype_{CMD} (1235) in preparation for the subsequent data transfer in the second read phase at 1263. The device then goes into the SD idle mode to wait for the second phase of the read process. A different variation on this solution will not use the LBA_{CMD} but a different address LBA_{READ} explicitly defined in the parameter of the write command. This method will work around cashing mechanism of the OS. In several systems the host OS will not attempt to read back a card address which was just written to. Instead it will return to the host application the data buffer fro a host cash buffer, assuming that this data is what the card has, since it was just written to it. In this case the data buffer will include the application-specific-command rather then the card response.

Returning to 1214, if the command (in the transmission protocol) is a write (Yes path from 1203), but a signature is lacking (No path from 1214), the command may actually be a write command in the transmission (here, SD) protocol, or may be additional data for a write in the application protocol. This is determined at 1215: if LBA_{CMD}≠LBA_{Wi} for any of the LBA_{Wi}, then it is a standard SD write which is then executed at 1217, after which the card goes into the SD idle state (1219). Should LBA_{CMD} match one of the LBA_{Wi}, then the command is actually more of the data portion for the corresponding application command and the flow goes to 1251 to write this additional application data.

Returning to step 1205, if the command is an SD read, it is determined whether it is actually an SD read or the second phase of an application read. This is determined at 1226 by comparing LBA_{CMD} with the LBA_{Ri}: if LBA_{CMD}≠LBA_{Ri} for any of the LBA_{Ri}, then it is a standard SD read which is then executed at 1227, after which the card goes into the SD idle state (1229). If LBA_{CMD} instead matches one of the LBA_{Ri} for any of the LBA_{Ri}, it is the second phase of an application read.

When LBA_{CMD}=LBA_{Ri}, the corresponding logical address is set as LBA_{Ri}=LBA_{CMD}+data blockcount (1261) and application data is read out (1263). The device then goes into the SD idle state (1269). For the application read process, the exemplary flow lacks the equivalent of steps 1255 and 1257 on the application write side. The keeps the corresponding read flag set even if all of the corresponding data has been accessed. By keeping the LBA_{Ri} open, the data can be re-read in case of an error. Under this arrangement, LBA_{Ri} is only cleared if the address is reassigned for another purpose, such as in step 1231, for one example.

These additions of FIG. 10A with respect to FIG. 10B allow for breaks in the transfer of application data. They also remove the need to read and write to same logical address. These allow the techniques to be used in cases where there may not be enough control over the operating system, as the sort of control needed for the embodiment of FIG. 10A may require a known controllable platform. Also, it should again be noted that FIG. 10B more explicitly incorporates that there may be multiple host applications, each communicating with card independently, and the breaks in data transfer may interpose part of an instruction from one protocol between portions of an instruction from another. Further, separate LBAs for both the read and write processes allow any read or write caching in the device driver layers to be bypassed.

### SECOND EXEMPLARY EMOBODIMENT

The first example was implemented at the file level. The various aspects of the present invention can also be implemented at the device driver level, initiating read and write operations by sending requests to the device driver, for example the Windows Standard Storage driver if the host uses the Windows operating system. This implementation of the command pass through method communicates directly with the device and does not have the file system overhead. However, this method may require administration rights. The host's application can try and use this method as first choice and move to file system operations if it fails. An interface function can be used to select between the methods and to initialize the communication pipe accordingly. The client application would call this command before any other operation. If the application lacks the proper administrator rights, working with this method will result an exception, which can be treated according to exception handling code.

This example is based on the discussion of the problem in the Background section above. Although the Background discussion presented the problem in the context of a memory card connected to a PC through a hardware card reader, it will be seen in the following that, as with the other examples given here, the situation is more general. The memory device may have such protocol translation-or, more accurately, non-translation-problems even when it connects directly to a second host. This situation may result when the memory device is connected to a host that has, as seen from the memory device, a less than complete protocol. One case where this may arise is where a card has two sets of contacts, one for use with an USB port and another for a standard set of card contacts. (Examples of such dual contact cards are described in U.S. patent application Ser. No. 29/203,693, U.S. Ser. No. 10/826,801, and U.S. Ser. No. 10/826,796, all filed Apr. 16, 2004.) As discussed with the third set of embodiments, the protocol translation may entirely be contained within the memory device itself, unknown to the host. Additionally, in the following, although the embodiments are described with respect to detachable memory card, the discussion is also applicable to embedded memory devices.

In a first set of embodiments for the second exemplary embodiment, to allow media card specific commands to be passed to the card from the host without changing the firmware of the adapter or the reader which hosts the media card, the present invention uses a specified logical block address (LBA), the Card Pass Through Mode LBA, with a special signature in the data sector to notify the card that a special command is embedded in the sector. This can be implemented by a firmware change to support the command pass through (CPT) mode. As this requires no firmware change of the adapter, the card can be run at any USB reader or adapter.

As discussed in the background section, the various small-format flash memory cards (Compact Flash Card, Secure Digital (SD) Card, the Multi-media Card (MMC), xD, and the Sony Memory Stick/Memory Stick Pro, etc.), have different electrical interfaces and often media specific commands for use with a host (digital cameras, flash-memory music players) that are not found in the command set of used between a PC and a hardware adapter allowing the PC to read the card.

In a primary aspect, the present invention uses a card firmware change to honor the normal read/write command. When the read/write command to a specific LBA offset, however, a signature is checked to determine if the data portion of the command contains embedded media card specific commands. The protocol can be implemented in the firmware of any media card. Therefore, it does not require any firmware change to the adapter, USB reader, or other reader used by the PC (or other host without access to the full, media-specific command set). In practical terms, this is simpler for the card manufacturer than implementing the reader firmware changes for all of the card commands in all vendors of the readers.

Although the various aspects of the present invention will often be described in terms of specific cards, such as the secure digital (SD) or compact flash (CF), and particular protocols, such as SCSI or ATA, when examples are discussed, it will be understood that the various aspects apply to the other various memory cards and system. Various details on card structure and operation are described further in the following patents and applications incorporated by reference through out this document.

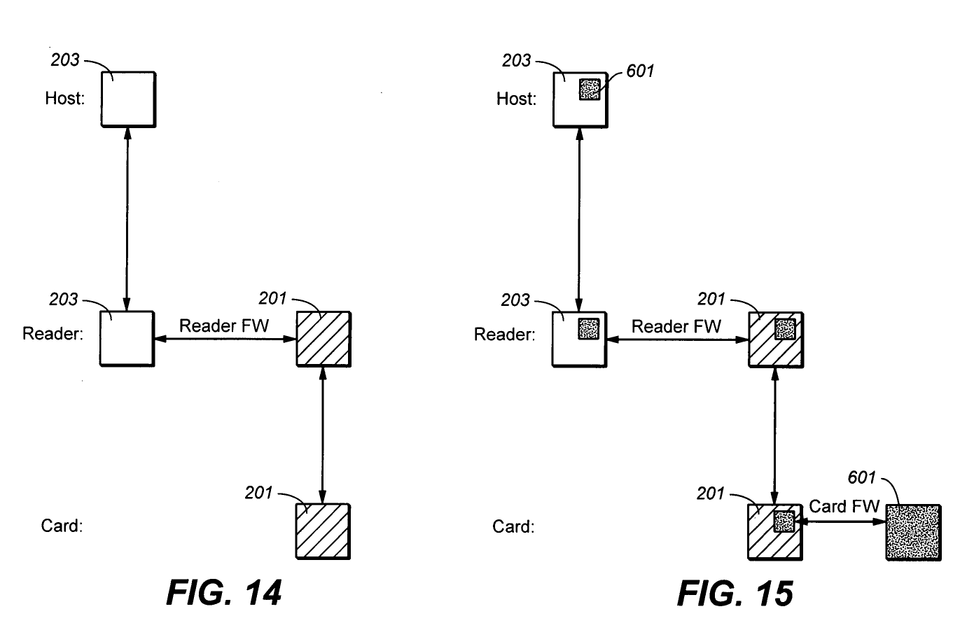

FIG. 14 shows the process whereby the card and a personal computer (or more generally any host requiring a hardware adapter to read the card) communicate using a reader. FIG. 14 is similar to FIG. 4 except that it ignores the explicit introduction of a USB wrapper or similar structure in some cases, which will also be suppressed in the following discussion. As noted in the background, the card and reader communicate using an instruction, such as indicated at 201, from the command set of the card's protocol. The host and reader typically communicate using an instruction, such as indicated at 203, from another command set. The reader serves to translate between the two command sets using its firmware. (Although firmware is referred to here and in the following, this may more generally be implemented in hardware, software, or some combination of these.) The difficulty is when command 201 is a command from the card's command set which has no equivalent in the protocol used by the PC to communicate with the reader. In this case, the reader is unable to translate 201 into a corresponding command 203 as there is no such equivalent instruction 203, and similarly for the other way around. Consequently, if the host wishes to use one of the card's media specific instructions, there is no way to pass this through the reader in the prior art without changing the command set of the PC-hardware adaptor protocol.

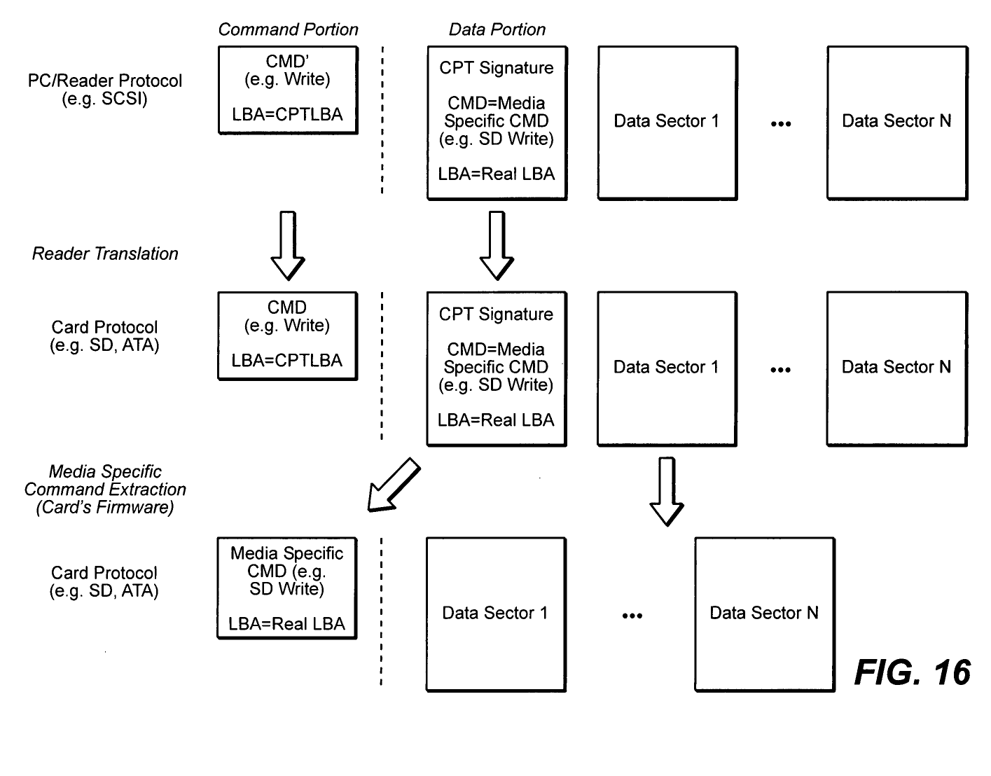

This particular example will use the SCSI protocol from host to reader, the SD protocol from reader to card, and an example of an SD command, say a secure write, that does not exist in the SCSI protocol as the embedded command. So although this command could be transmitted directly in the SD card, it needs to use aspects of the present invention for the host side of the application to be able to transmit the instruction in the intermediate SCSI protocol that carries the command between the host and reader. At the reader, the dummy command has a version in each protocol and can be translated between the protocols, with the actual embedded command being treated as data. For example, the dummy command is again taken as a write. Thus, between the host and the adapter it will be manifested as an SCSI write command and between the adapter and the card will be manifested as an SD command, while in both cases the actual command is embedded in the data portion. So although in this example the embedded command now exists in the second protocol, it is still embedded since, at some point along the way, it is passed through on a protocol lacking this application specific command. Consequently, this results in a command of first protocol being embedded in a command of the same protocol, allowing translation between it and another, second protocol that lacks an equivalent of the embedded command. This is shown in FIG. 15. Although this discussion is primarily discussed in terms of an SCSI and SD embodiment, it will be appreciated that is applies more generally to other protocols.

FIG. 15 is a schematic representation of a principle aspect of the present invention when a command form the card's command set that has no equivalent in the PC-reader command set is embedded in an instruction 203 of the PC-reader protocol which has a representation in both command sets. In the exemplary embodiments, the media specific command is again embedded in the data portion of the PC-reader protocol. The PC and reader can then exchange a command 203 which the reader can translate into a corresponding command 201. Within this command, however, is embedded another, media specific command 601. The reader then passes through and translates this command in a manner transparent to its operation. The mechanism of the exemplary embodiment is that the instruction 201/203, which has a representation in both command sets, is an access to a predetermined logical address in the card's memory. When, for example, the card receives a read command to the specified logical address, the card is alerted that this may be a media specific command 601. (As descried in the following, the embodiments below do not rely on such a specified logical address and, more generally, not just a write command, but any command with a data portion may be utilized.) The card then checks for the signature of such a command to verify this and then extracts the command 601. In the exemplary embodiment, the command 601 is placed inside the data portion of the instruction since, in SCSI and other protocols, there is often no convenient place to embed the media specific command in the command portion of the instruction.

For example, if a PC wishes to make a write of the secure area of an SD card, it will form instruction 203 that consists of a write command to the specified logical block address (LBA), contains the command pass through (CPT) signature, and contains the actual secure write command 601 embedded in the data portion. The PC then sends this instruction 203 to the reader, which interprets it as a standard write instruction in the SCSI protocol. This is then translated by the reader into a standard write instruction 201 in the SD protocol. The reader just passes through the secure write command 601 assuming it is part of the data attached to the write command. When the instruction 201 arrives at the card, based on the LBA specified for the write, the firmware allows the card to determine that the instruction is instead a media specific command. The controller then extracts the command 601, which it recognizes as a secure write, and proceeds to execute the command by performing a secure write of the actual data portion of the instruction.

FIG. 16 describes a particular embodiment in more detail for the example of performing a secure data write of N sectors of data to an SD card. The top row shows the instruction as formed by the host. As the secure data write does not have an analog in the SCSI protocol of the example, the command portion consists of a command CMD′ in the SCSI protocol, here a write, that exists in both command sets. The write is to the specified command pass through logical block address, CPTLBA. (The other details of the command are not shown in order to simplify the discussion.) The data portion, to the right of the broken line, consists of an initial sector, containing the media specific command, followed N sectors of the actual data. The initial data sector will include the command pass through signature, the actual media specific command, and the actual address where the following data is going to be written. The logical block address CPTLBA corresponds to the logical block address LBA_XYZ used in the discussion of the first exemplary embodiments discussed above (see, for example FIG. 10A). The different labeling is used to indicate that in the present example, implemented on the host side at the device driver level, the logical block address being used is a particular, specified logical block address, whereas in the previous example, implemented at the file level, it can be taken as any address.

FIG. 16 is similar to FIG. 5 discussed previously, but with the instruction 510 repeated once for each of the transmission protocols (host to reader, reader to device) explicitly shown in this example. Instruction 510 of FIG. 5 shows the embedding of the command CMD as this will occur somewhere along the transmission path between the host and device sides of the application, while instruction 530 shows the extracted form as it will be used by the device side of the application. FIG. 16 illustrates that there may be several intermediate protocols and that the actual command (CMD) will stay embedded through several of these, even in cases where the embedded command has an analogue in a particular intermediate protocol.

As seen by the reader, the first data sector is just the first of what it sees as N+1 sectors of data to be written to the specified logical block address. As such these pass through unchanged in content. The command portion of the instruction is translated by the reader from its representation in the PC/reader protocol (CMD) to its representation in the card's protocol (CMD). At this point, the instruction can be communicated to the card and still has the form of, say, a write command to CPTLBA followed by N+1 sectors of data.

Once in the card, the firmware can disentangle the actual command. As it determines that the command uses the specified address, it then goes to the first data sector, checks the CPT signature, and extracts the actual, media specific command. This then forms the actual command of the instruction, which is then followed by the N sectors of actual data.

Consequently, as described with respect to FIG. 16, a media specific write command with N sectors of data becomes embedded as N+1 sectors of data in the transmission protocol used between the PC and the reader. In order to read N sectors of data, the media-specific read command is embedded as one sector of data in a read (or other command that accepts data) or the transmission protocol used between the PC and the reader. Thus, media specific read command can be implemented as a write command with the media specific read command embedded in the only sector of data. Again based on the specified logical address (CPTLBA) and signature, the card will extract the media specific command and respond with data from the requested logical block address specified in the media specific read. Details on read implementations and methods for dealing with complications such as a write or read failure were developed further above with respect to the first exemplary embodiments.

The specified logical address (CPTLBA) is preferably a sector not normally used in the file system, as this can avoid conflicts with standard read or write commands that may be sent to this sector. For example, in DOS, after the master boot record, there are usually some hidden sectors not usually accessed. (In some operating systems, accessing this area may require administrator privileges, a possible complication that can be bypassed in the file-based implementations of the next section.) By taking this logical address as the specified logical address, an access to this address will not really be to read or write data there, but for the purpose of checking that the actual command is an embedded media specific command. The reader will just pass though this command as a normal data access and the card sorts everything out.

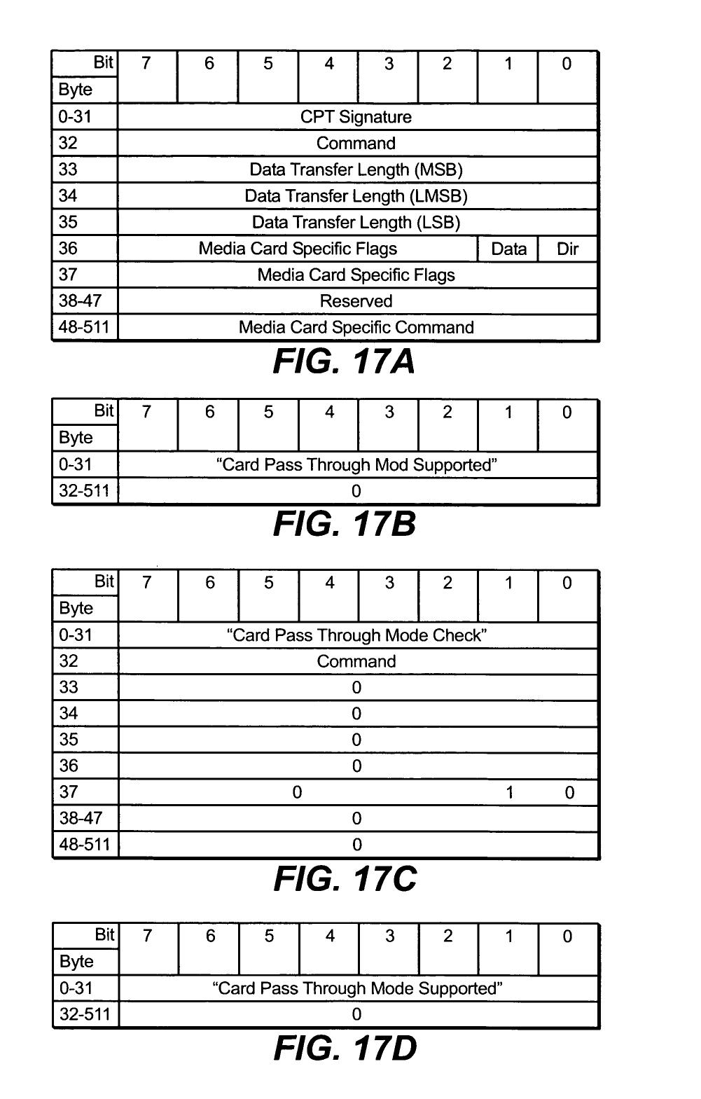

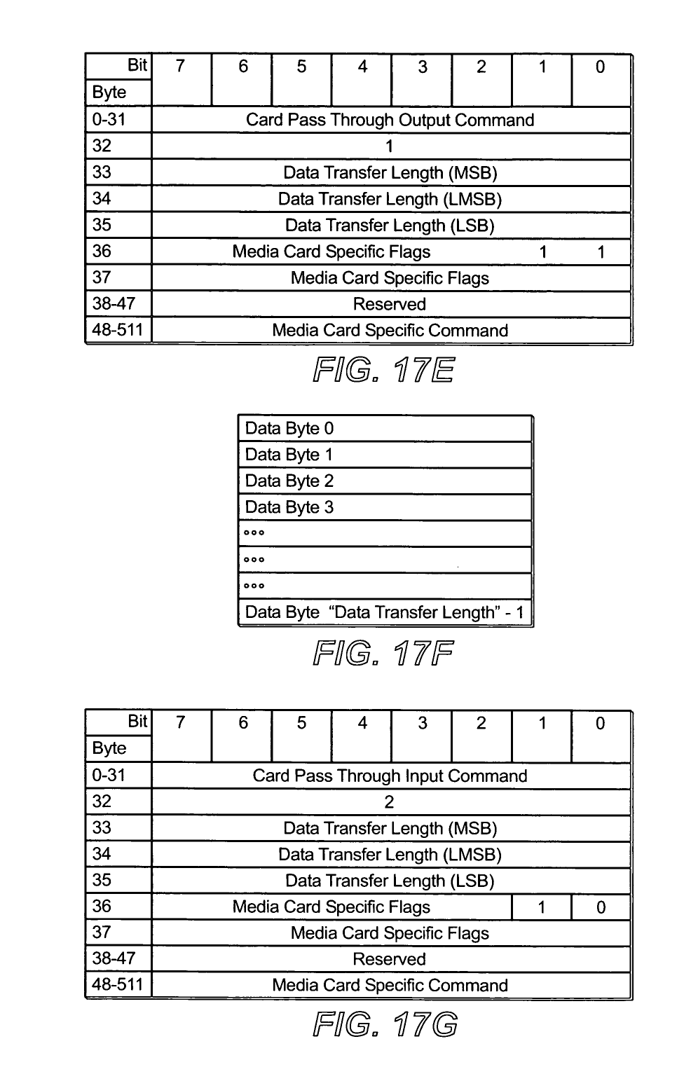

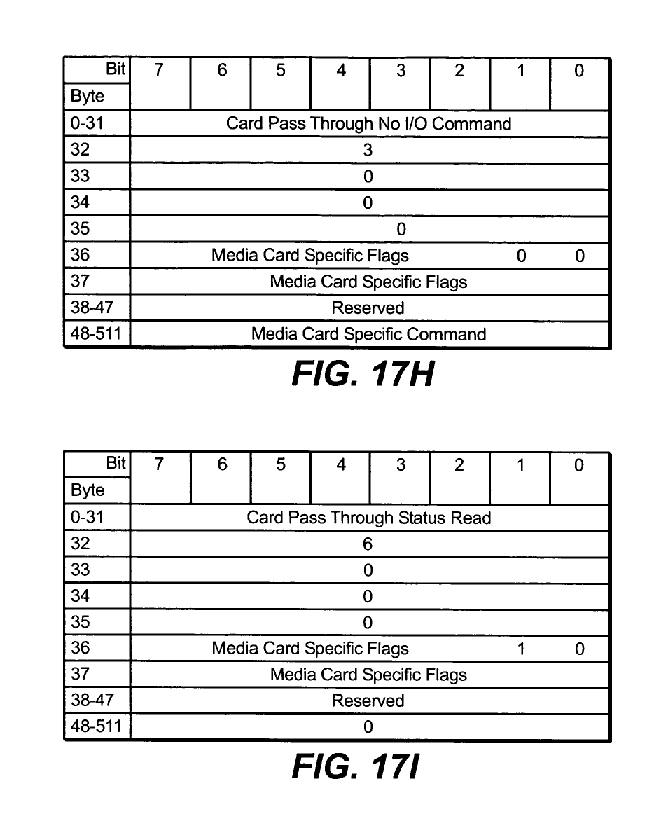

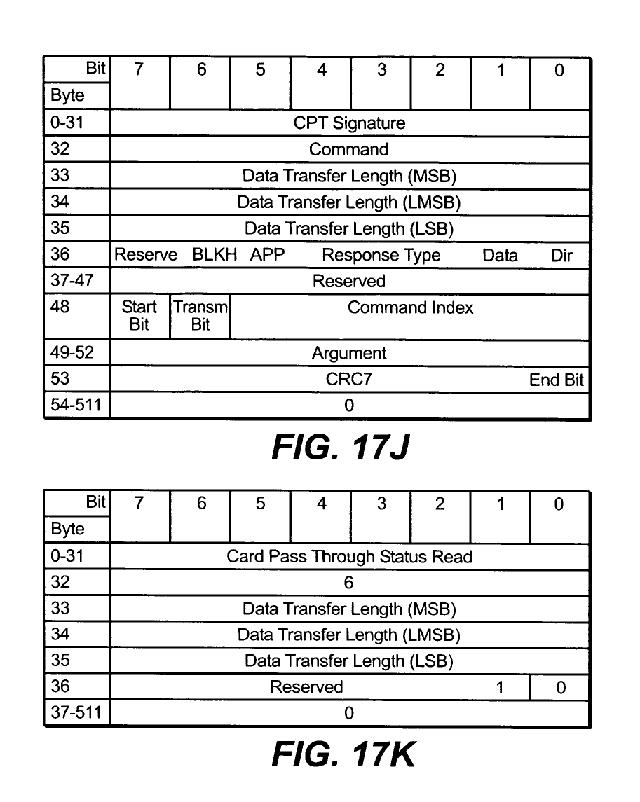

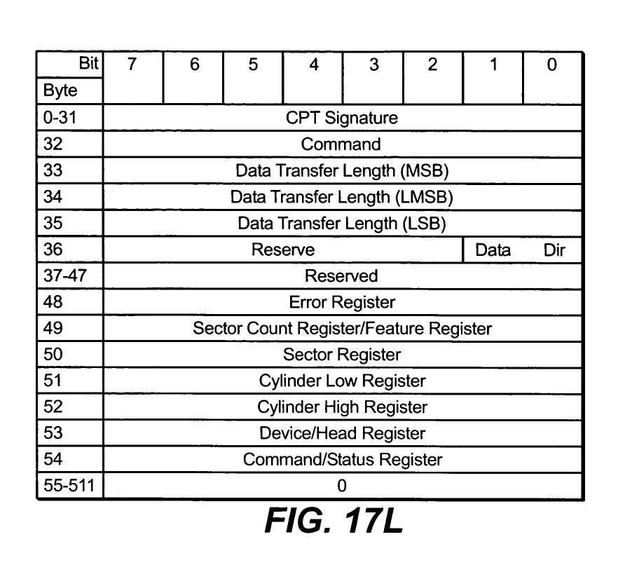

FIGS. 17A-17L show one embodiment of how various examples of commands can be embedded into a data sector. As described above, when a write to the media card is performed, the first sector of the data portion contains the CPT (card pass through) command. It indicates the CPT function to be executed. Consequently, to write 10 sectors, it actually writes 11 sectors because the first sector is a CPT header. To read 10 sectors, the user needs to send one write of CPT command then read 10 sectors. The real application is to perform special commands that cannot be achieved by the normally read or write command. For example, the CPT mode can be used for media specific commands, such as AKE (Authentication Key Exchange) or application command for the SD card.

FIG. 17A shows an embedded command format embodiment. The CPT Signature in bytes 0-31 is string of characters that depends on the command to check that the signature matches the command. Commands, in byte 32, can include:
0—CPT Mode Check: Intend to check the media card for CPT mode support Signature “Card Pass Through Mode Check”
1—Data Out: Data to be written to the media card Signature “Card Pass Through Output Command”
2—Data In: Data to be read from the media card Signature “Card Pass Through Input Command”
3—Command without data transfer Signature “Card Pass Through No I/O Command”
4—CPT Command abort Signature “Card Pass Through Abort Command”
5—CPT mode reset Signature “Card Pass Through Reset Command”
6—CPT status retrieve Signature “Card Pass Through Status Read”
   Data Transfer Length (bytes 33-35) specifies the amount of data (as a number of bytes) to be transferred; since data is transferred in sectors, an incomplete sector is padded out by 0s. Data (byte 36, bit 1) is flag for data transfer and “0” if there is no data transfer on the next command, “1” there is data transfer on the next command. Similarly, Dir (byte 36, bit 0) is flag for the direction of data transfer and “0” if data transfer is for input on the next command, “1”—if data transfer is for output on the next command.

The Media Card Specific command area (bytes 48-511) is the real command that the media card will run when it is extracted. The Media Card Specific Flags area (byte 36, bit 0) is for media dependent flags.

The media card must be checked if it supports the Card Pass Through command protocol before the real commands are sent. As described above, a LBA (CPTLBA—Card Pass Through LBA) is designated for the protocol. The LBA can be any number from 0 to the last sector of the card. In the example, this will be the LBA 2, which is the second hidden sector after the master boot record in FAT file system and is typically not used to hold data. Note that even if that LBA contains valid data, this protocol will preserved its values. There are two options for checking the mode support.

The first option to query for support of the protocol is for when the media card puts the CPT mode support signature in the CPTLBA sector. However, this is not preferred if the CPTLBA is a sector that has valid information; e.g., the sector in the FAT/Directory or user data area. If the CPT mode is supported, optionally the card can return the CPTLBA sector with the signature as shown in FIG. 17B, where Bytes 0-31 are “Card Pass Through Mode Supported (padded with blanks)” and bytes 32-511 are 0.

The second option to query for support of the protocol can be used if the CPTLBA sector does not contain the signature supporting CPT mode. In this case, the following protocols are used to check the mode support:
a) Read and save the CPTLBA sector in the host memory area. (No supporting signature)
b) Write the CPTLBA with a sector containing signature for query the CPT mode support.
c) Read the CPTLBA sector for checking the response of CPT mode support.
d) Write the CPTLBA with an original sector from the saved memory area.
   Step a) allows for the specified logical address (CPTLBA) to be checked for support while still maintaining any data that may be contained in it as the host reads the CPTLBA sector and save the save in the memory. This is to restore the sector in case the media card does not support the Card Pass Through mode. This write does not use CPT mode command.

FIG. 17C shows step b), the writing of the CPTLBA with a sector containing signature for query. Bytes 0-31 contain The host writes the CPTLBA sector with bytes 0-31 as “Card Pass Through Mode Check” (padded with blanks), followed by the command and flags in bytes 32-47. Bytes 48-511 are 0.

In step c), the host reads the CPTLBA sector for the response. If the response is as in FIG. 17D, with bytes 0-31 as “Card Pass Through Mode Supported” (padded with blanks) and bytes 32-511 as 0, The Card Pass Through mode is supported; otherwise, the card does not support CPT protocols. Note that this protocol is different from the first option to query for support of the protocol. The signature is responded when a CPT mode check command is issued.

In step d), the host writes the original data of the CPTLBA sector from the saved memory area. Note that even if the card supports the Card Pass Through mode, this write will not be interpreted as a special CPT command because there is no proper signature.

The input/output protocol is described with respect to FIGS. 17E-17G. To output data to the media card, first writes the CPTLBA with the signature for output, followed by writing the data based on the Data Transfer Length. To write CPTLBA with the signature for output, the host sends a write command to the media card, where the data has the CPT command format with media card specific command embedded. The length is the “Data Transfer length” plus the one sector for the CPT command format. This is shown in FIG. 17E, where the 1 in byte 32 corresponds to the “Data to be written to the media card”.

The actual write based on based on the Data Transfer Length is shown in FIG. 17F, where how the media card treats the data depends on the Media Card Specific command. As noted with respect to FIG. 17A, the “Data Transfer Length” information in this example is expressed in bytes 33-35 (MSB, LMSB, LSB) in terms of bytes. However, as the read/write data is transferred between the card and the reader in sectors, incomplete sectors can be padded out with 0s if needed. (For example, in the SD card the Authentication Key Exchange (AKE) process uses 8 bytes for challenge and response. Consequently, the host pads out the data sectors with 504 bytes of 0s for challenge1 and response2 data, with the card similarly padding out the challenge2 and response1 data.

To input data from the media card, the host writes the CPTLBA with the signature for input and then reads the data based on the Data Transfer Length. FIG. 17G shows a CPT command to be sent to indicate data are to be read, where the 2 in byte 32 corresponds to the “Data to be read from the media card”. To read the data based on the Data Transfer Length, after the host sends a read command to the media card the number of sector to be read are [(Data Transfer Length)/512]. (This is assuming 512 bytes per sector; more generally, the actual sector lengths would replace 512 if different.). The starting sector is CPTLBA. Since the previous command is a CPT Input command, the card will send the data to the host based on the Media Card Specific command.

Examples of commands without input or output include “Command without data transfer”, “CPT Command abort”, and “CPT mode reset”. FIG. 17H shows “Command without data transfer”, as indicated by the 3 at byte 32.

FIG. 17I shows a “status read” command, indicated by the 6 at byte 32, that allows the host to read the CPT status. For example in an SD card, the status can be implemented as the response data. The status will the first few bytes of the data read back.

Although reference is made to the SD card when a concrete example is needed, FIGS. 17A-17I are not restricted to any particular media protocol and are not media specific commands. To give examples of media specific commands, FIG. 17J shows an embedded command specific to an SD or MMC card and FIG. 17L shows an embedded command specific to a compact flash card.

In FIG. 17J, shows the command format for the SD/MMC example. Bytes 0-35 are as described above. The SD/MMC command fills the Media Card Specific command field. The bytes 48-53 are the SD command, for example a secure read. Some of the flags are required and defined in the Media Card Specific flag field. BLKH indicates whether the command is for a single sector or multiple sectors: 0 if single sector command is used and 1 if multi-sector command is used. APP=1 for an application command. Response Type is the SD response type depending on the command index. The various entries in bytes 48-52 are the actual elements of the SD command, where CRC7 in byte 53 may be optionally set to 0.

To get the response data of the SD command, the user can send status retrieve to get the response. This is shown in FIG. 17K. The response data will be returned as the first 6 bytes of the sector read.

FIG. 17L shows the compact flash (CF) command format for an embedded command. In this case, the command is in bytes 48-54 and provides the elements need to comprise a CF command. In FIG. 17L, Media Card Specific Flags (byte 36-bit 2 to byte 37) are reserved for future commands specific to various card formats.

### THIRD EXEMPLARY EMBODIMENT

The third exemplary embodiment is implemented at the file level, as was the first exemplary embodiment. Here the discussion will focus more on the details of what is placed in the file on the host side. Since device specific commands are embedded within file, there is no way to harm file system specific data such as FAT area. From the card's point of view, the different exemplary embodiments will appear similar, the difference more being with respect to how the information is packaged on the host side. When reference is needed to a particular application, the third exemplary embodiment will be that of a secure link to a secure bus, such as that presented in U.S. provisional patent application 60/638,804, filed Dec. 21, 2004, which is incorporated by above.

With the file level implementation, in addition to overcoming the sort of privilege problems that may arise with device driver level implementations, it is also possible to overcome a possible need to have special hardware to send special commands. For example, in some cases at the device driver level, there is a need to have to send special commands to access secure area of the SD card, but with file level implementation there is no longer a need for this as the information is packaged within file. So, as long as a file can be written and read, any command set can be sent and received with this implementation.

The embodiments of the preceding section are a card driver implementation, operating at the device input/output level. Between the host or PC application and the device or card driver is the operating system (OS) file system. The third set of embodiments is a file I/O implementation, operating on the OS file system. In these embodiments, the host simply tells the file system to write a file to memory device, where the device specific command is again embedded. More details on the writing of files to a flash memory are described in U.S. patent application Ser. Nos. 11/060,249, 11/060,174, and 11/060,248, all filed Feb. 16, 2005, and which are all hereby incorporated by reference. Although these embodiments may require a little more firmware overhead than the device level embodiments, they can have a number of advantages. For example, at the device level, there is a need to have some knowledge of the hardware involved as an application is developed, whereas by using a file system this becomes independent of the hardware and independent of many details of the bottom level protocol

As with the device level embodiments, the file level embodiments can be used to send vendor specific command to respective vendor products, such as Advanced SCSI Programming Interface (ASPI) found in Windows 98/ME/95/DOS and similar examples. In the device level embodiments described above, use was made of a write to a specific logical address, the CPTLBA. In many operating systems, however, to access this logical address requires certain access privileges. For example, certain SCSI command cannot be sent to vendor products if the user has no administrator privileges. As the operating system generally allows the writing of a file, the file level embodiments of the present invention circumvent this privilege problem by embedding the media specific commands in a file, writing the file to the device, and de-embedding the actual on the device. In many versions of the Windows operating system, the card level embodiment using the exemplary CPTLBA will require administrator privileges, while writing a file will not require any such special access privileges. As before, the exemplary embodiments embed the media specific commands in a data portion of an instruction.

The implementation at the operating system's file system level can again be implemented by the card's card firmware, which is adapted to comply and recognize the protocol. With a read/write command to any LBA, a signature is checked to determine if the data contains embedded media card specific commands. This differs form the device driver implementation where a specific address is used. In other ways, as seen from the card there is little difference between the device driver level embodiments of this section and the file system level embodiments of the preceding section.

As in the preceding section, the exemplary embodiment of a file-based implementation divides the protocol into an “instruction” part, in which the media specific command is embedded, and a “data in/out” part, if the command involves any data transfer, to hold the data associated with the command. When the protocol command is received by the card, the firmware checks for a special signature during the read or write operation to determine if the given LBA is the instruction part, this need only be done for the first data sector of the protocol command for embodiments where the signature is always embedded in the first data sector. From the host side programmer's point of view, the client application issues a simple file or logical sector (LBA) write operation having an instruction part and, maybe, a data in/out part. The firmware performs the logical to physical mapping if the command involves either reading data or writing data to the media. The firmware would detect API instruction part during what is received as a write or read from the transmission protocol.

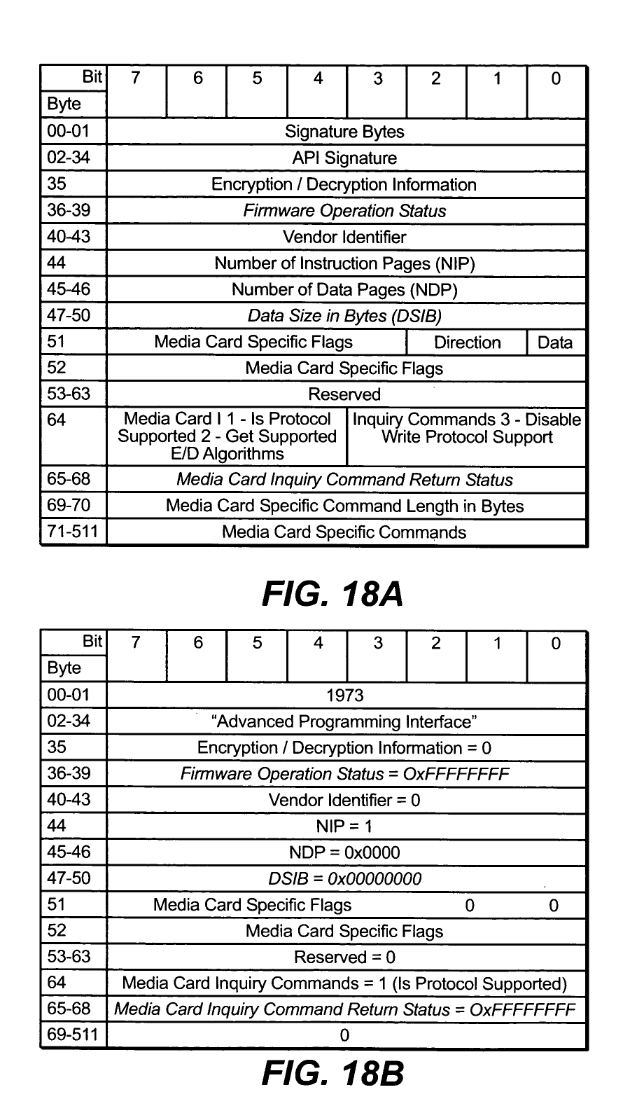

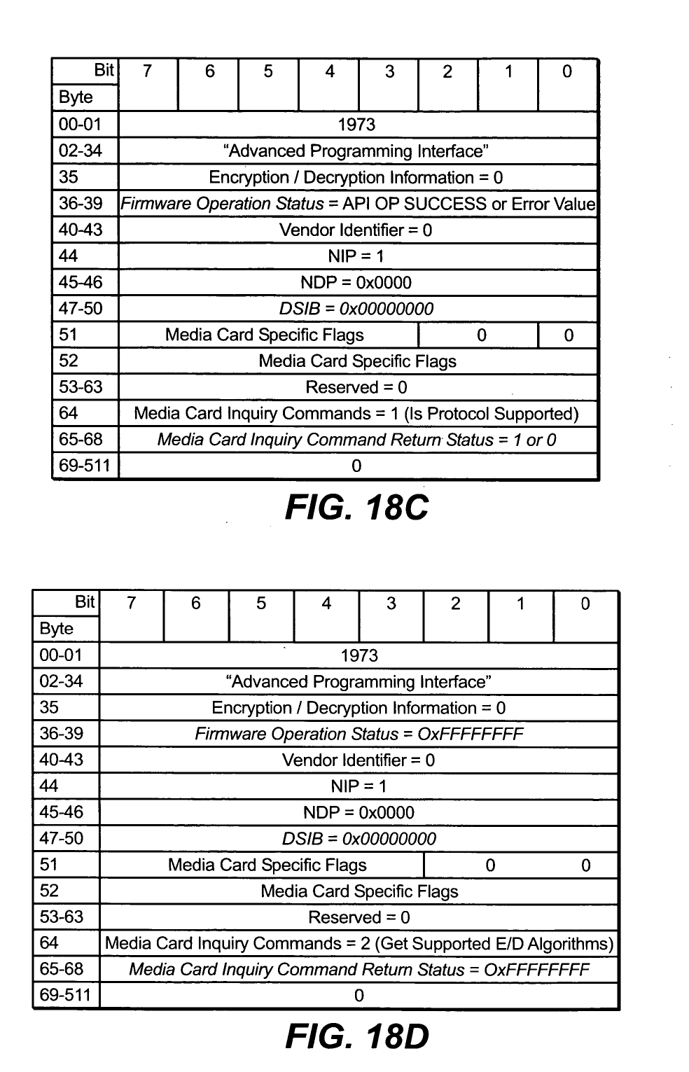

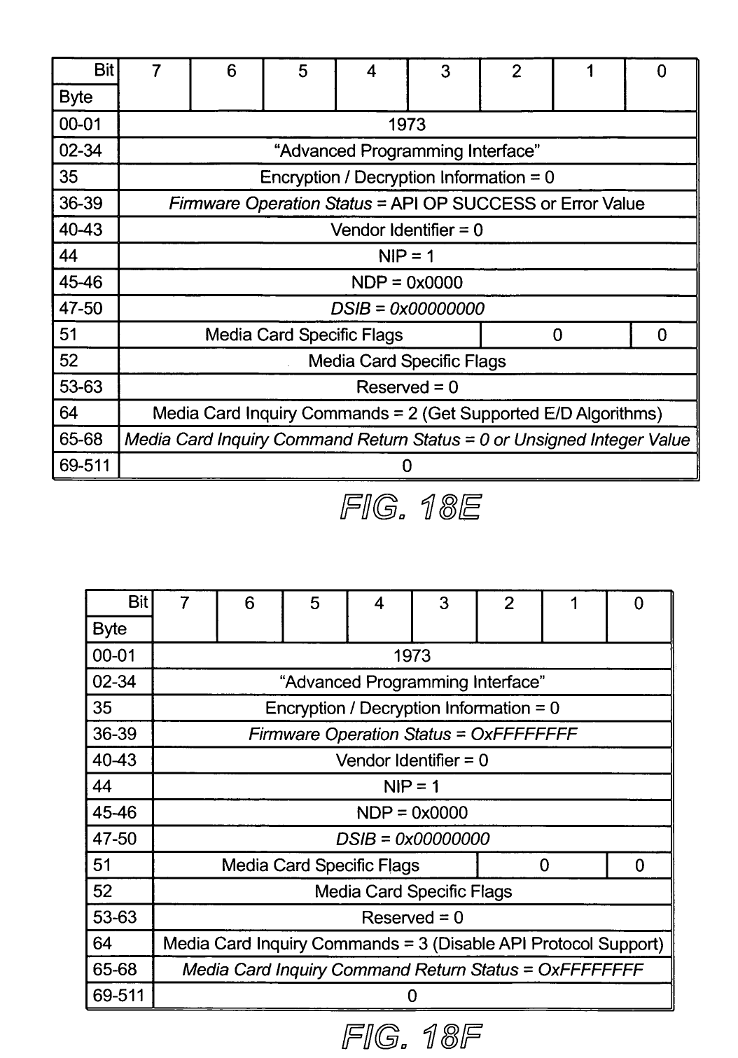

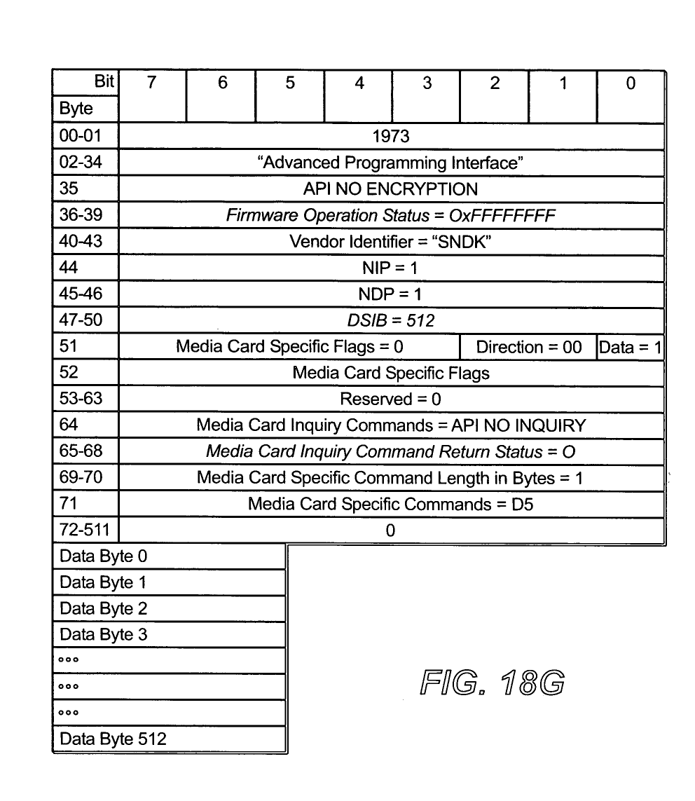

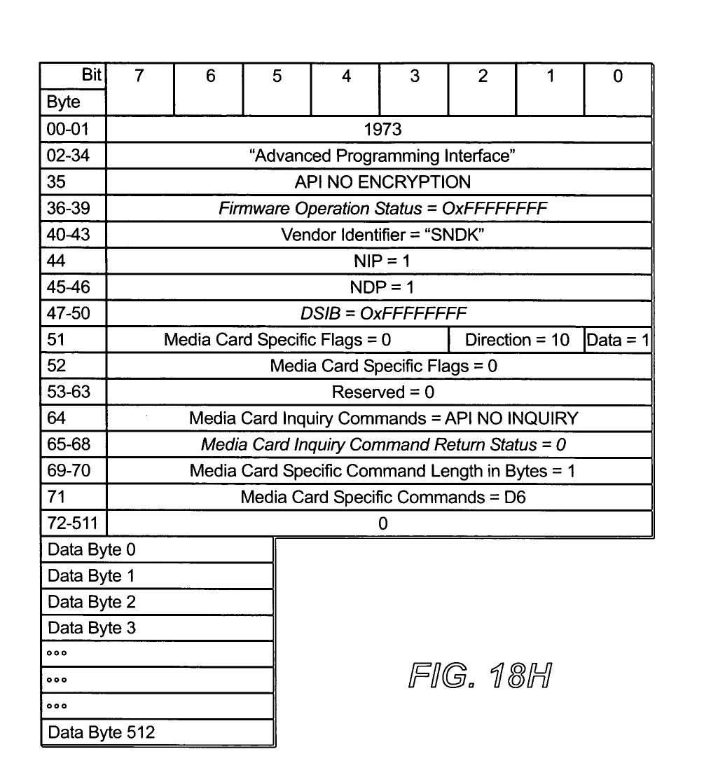

In an exemplary embodiment, the instruction portion of the protocol command will contains signatures, inquiry commands, vendor specific commands, and updateable fields. The size here will be restricted to a multiple of 512 bytes (which is the size of a most commonly used data block). The format of the instruction page in the exemplary embodiment is shown in FIG. 18A, which is quite similar to FIG. 17A but with additional detail. The first 36 bytes are not encrypted, with the rest encrypted/decrypted according to the Encryption/Decryption information that states the presence of the supported encryption algorithm.

Referring to the various fields shown in FIG. 18A, Bytes 0 and 1 are the signature bytes used to indicate an LBA that could be a candidate for API instruction pages. The firmware will check the API signature if these two bytes match. In the following example, for Byte 0 is 19, and Byte 1 is 73. The API signature follows in bits 2-34 and is a string of single by characters. In the following example, the signature is taken as “Advanced Programming Interface”.

Byte 35 is Encryption/Decryption (E/D) information that tells the firmware if the subsequent instruction pages and data pages are encrypted. If it is not encrypted, then this field should be set to API_NO_ENCRYPTION; otherwise, it should be set to encryption name so that the firmware can decrypt and encrypt the instruction page or pages starting from byte 36 and data pages. Bytes 36-39 are the Firmware Operation Status Field field and will be updated based on the success or failure of the operation. It will be set to API_OP_SUCCESS if everything is OK; otherwise, it will be set to error values or API_OP_NO_SUCCESS. It is suggested that its default value be set to 0xFFFFFFFF when issuing command. After writing, the caller can read instruction page to verify the whether or not the requested operation succeeded. The Vendor Identifier field (Bytes 40-43) can be used as an unique vendor identifier. This field can be used by the calling environment to identify itself to the firmware if the firmware also requires a valid vendor ID.

The Number of Instruction Pages field (Byte 44) tells the firmware the total number of instruction pages, where the instruction pages are on the 512 bytes boundary. Similarly, the Number of Data Pages field (Bytes 45-46) tells the firmware total number of data in/out pages attached to the Instruction part. Data page size does not necessarily mean the data size in bytes; in certain cases, padding may have been added to the end of the data bytes. For example, DES requires that the data size in bytes must be a multiple of eight. The Data Size in Bytes field (Bytes 47-50) field tells the firmware total number of bytes within the data page than contain valid data. In the case of reading from the media, this field should be updated by the firmware with the actual processed byte size within the page area. In terms of writing data to the media, this is length in bytes of the data size. If data is encrypted, then the firmware first decrypts the whole content of data pages and then does the extraction. Byte 51, bit 0 is a flag for data transfer, set to “0” if current command does not require data transfer and set to 1 if current command requires data transfer.

Byte 51, bits 1 and 2 are a flag for the direction of the data transfer. The value “00” indicates that the data transfer is for input on the current command and the firmware will process commands during write time and will nullify the data pages once written to the media. The value “01” indicates that the data transfer is for input on the current command and the firmware will process commands during write time with no nullification. The value “10” indicates that the data transfer is for output on the current command. The value “11” is reserved. Byte 51, bit 3 to Byte 52 are Media Card Specific Flags and depend on the type of the media card. Bytes 53-63 are fields_reserved for future use.

The Media Card Inquiry commands field (Byte 64) will be used to inquire the current state and capabilities of the media card. Known supports include: Is API protocol Supported; Get supported E/D algorithms; and Disable API Protocol Support. The Media Card Inquiry Command Return Status field (Bytes 65-68) can be used to hold the return value of the Media Card Inquiry Commands.

Media Card Specific command length (Bytes 69 and 70) specifies the total number of command bytes that command field stores, where the real command that the media card will run is in Media Card Specific command (Bytes 71-511).

Appended to the instruction page(s) will be any data in/out pages. The caller environment and the firmware based on established cryptosystem algorithm will encrypt/decrypt content. In some cases it is not desirable to write the data pages to the media, in which case the firmware must process the commands before writing and then write the instruction page only to the media so the user can read it back and see the status of the operation.

FIGS. 18B-F give several examples of media specific inquiry commands, such as a query for support of the API protocol used to check on whether the media card supports the API protocol before the real commands are sent. A particular procedure is illustrated with respect to FIGS. 18B and 18C. When a file system is used to access the media, a file will be written having content of only one instruction page. The example of FIGS. 18B and 18C will demonstrate how to query the protocol through the file system.

Calling environment opens a file, say “myAPI.bin”. To inquiry for support of the protocol, the caller can write 512 bytes, shown in FIG. 18B, to the file and issues a write file command. After issuing the write file command, the media will take appropriate actions, whether during the writing of the file to the media or during reading it. For the example, assume the media card processes the instruction page before writing. In this case, the following actions will be taken:
a) Verify Signature Bytes
b) If match, verify API signature
c) If match, go through media specific flags if any.
d) Check Media Card Inquiry Command request, which is 1
e) Verify that the data field and Direction field is 0 as there is no data transfer.
f) Process commands, update the fields and write the file to the media. When the user reads the file, myAPI.file, from the media caller needs to check two fields: (1) Firmware Operation Status: If command operation completed successfully this field will be updated with API_OP_SUCCESS or some error values if it failed and (2) Media Card Inquiry Command Return Status will be checked only when command operation completed successfully. The field will be updated with 1 if the protocol is supported or with 0 if it is not. See FIG. 18C.
   If protocol is not supported, or the card have been disabled for this protocol support, these two updateable fields will have maintain their initial default values of 0xFFFFFFFF.

A second example of a media specific inquiry command is a query to determine which encryption/decryption algorithms are supported, where the media card must be checks if the API protocol is supported and active before this query. This is illustrated using FIGS. 18D and 18E. Similarly to the a query for support of the API protocol, discussed with respect to FIGS. 18B and 18C, when using a file-type system to access the media, a file will be written having content of only one instruction page. The calling environment will write a file; say, myAPI.bin to use the same example as before.

Calling environment will write a file; say myAPI.bin. To inquire about support for this command, the user will include 512 bytes as show in FIG. 18D and issue a write file command. Assuming that the media card processes the instruction page before writing, then an exemplary set of actions is as follows:
a) Verify Signature Bytes;
b) If match, verify API signature;
c) If match, go through media specific flags if any;
d) Check Media Card Inquiry Command request, which is 2;
e) Verify that the Data field and Direction field is 0 as there is no data transfer; and
f) Process commands, update the fields, and write the file to the media. When the user reads the file, myAPI.bin, from the media, the caller will check two fields: (1) Firmware Operation Status: If command operation completed successfully this field will be updated with API_OP_SUCCESS or some error value if it failed and (2) Media Card Inquiry Command Return Status will be checked only when command operation completed successfully. This filed will return a 32-bit integer, where 0 means no encryption/decryption algorithm is supported. Otherwise each bit for each predefined encryption/decryption algorithms will be set. For example, suppose DES is in Bit 1, 3DES is in bit 3, and AES is in bit 32, then return value should be:
MSB 10000000 00000000 00000000 00001010 LSB
   The result is shown in FIG. 18E. Note that the maximum number of algorithms is 32 in the exemplary embodiment. Based on the return value, one can determine the type of the E/D algorithm that is supported so it can encrypt instruction page (starting from byte 36) and data pages by setting the same predefined algorithm name in byte 35. Note that byte 35 should have only one bit set at any given time. If more than 1 bit is set, then it will fail.

Another example of a media specific inquiry command is a query to determine if the media card supports the API protocol and if so, disable it. Similarly to the query to determine which encryption/decryption algorithms are supported, a file will be opened where the content of the file will have only one instruction page. Calling environment will open a file, say, again, myAPI.bin. To inquiry about the support for this command, a user could include the 512 bytes shown in FIG. 18F in a file and issue a write file command.

After writing the file, a user can read the fields and verify if the Operation Completed Successfully by first checking: (1) Firmware Operation Status: If the command operation is successfully completed, this field will be updated with 0 or 1 if it failed; and (2) Media Card Inquiry Command Return Status will be checked only when the command operation is completed successfully. It will be 1 if protocol is disabled or be 0 for failure.

FIGS. 18G and 18H show particular examples of file system based, media specific read and write commands. Prior to issuing a firmware command to the media card, the card is checked to see whether or not it supports the API protocol. As with the previous protocol, if a file system is used to access the media, then a file will be opened with content of one or more instruction pages and any associated data pages. An example of a media specific write command is shown in FIG. 18G.

More specifically, suppose that the caller wants to issue a command (e.g. “D5” in the SD card command set) to take the data page and write it to some hidden area. The calling environment will open a file and the user will prepare the data page as shown in FIG. 18G. Bytes 00-34 are as in FIGS. 18A-18F, with Byte 35 of the instruction in this example indicating that there is no encryption being used. Bytes 36-39 again indicates the operation status of the firmware, where the italics (both here and in the preceding) indicating that the field is firmware updatable, and the vendor or media identifier (the example will use the Vendor Identifier as “SNDK”) follows in Bytes 40-43. The embedded command will then be specific to this media/vendor. Bytes 44-50 indicate the number of instruction pages, here only the shown page (NIP=1), the number of data pages, also one in the example (NDP=1), and the data size specified as the number of bytes, here taken as the 512 bytes of a sector (DSIB=512). Bytes 51-68 of the instruction provide the previously described instruction information as needed for the specific command.

The actual embedded command has its length (in bytes) specified in bytes 69-70, which in this case is the single byte 71 contained the exemplary “D5” instruction indicating a write to a reserved or secure area. The remaining area allocated for the media specific instruction (bytes 72-511) is then padded out with zeros to make a full sector. The (here) 512 bytes of data for the actual specific command follow as the next sector.

In FIG. 18G, note that data field (DATA=1) indicates that this instruction contains “input” and that the direction field (Direction=00) tells the firmware to process the data and write the page to media. Since file system will write the data pages to media (1024 bytes as seen by the file system, the first 512 being for the embedded command), the firmware will pad out data pages with 0s or FFs as needed.

The caller can verify if the operation has succeeded by reading the file from the media card and checking the Firmware Operation Status field. If the operation has been completed successfully, this field will be updated with API_OP_SUCCESS or, if not successful, it will be updated with some error values or API_OP_NO_SUCCESS. Note that since the direction was 00, the data pages should be 0s or FFs.

Assuming that the media card processes the instruction page before writing, then an exemplary set of actions is as follows:
a) Verify Signature Bytes;
b) If the signature matches, verify the API signature;
c) Check if the instruction page (from Byte 36) is encrypted;
d) If encrypted, decrypt the Instruction page (from Byte 36) and data pages;
e) Verify the Vendor ID signature;
f) If the Vendor ID matches, go through media specific flags (if any);
g) Check Direction and Data fields;
h) Process the actual embedded, media specific commands; and
i) Update the Instruction Page's Firmware Operation Status field, encrypt (if requested) the instruction page after byte 36, and write it to the media. Since the direction is 00, write data pages as 0s or FFs as needed.

Media specific read commands can be implemented in a number of ways, some of which are discussed more in the following section. An implementation of a file system based, media specific read command, which is similar in structure to the write structure of FIG. 18G, is described with respect to FIG. 18H.

The media specific command is now D6 and Direction is 10, as it is reading from the media. In addition, there is the flexibility to modify the content based on what command and established protocol are used. For example, the card can be told to write this file and the file has special command to tell firmware to encrypt the content before writing. Thus, the written content may be transformed to another form before being written. The same can also be applied to read operation as well.

FIG. 18H shows the case where the caller wants to issue a command (e.g. “D6” in the SD card command set) to read a sector of data from a hidden area and place it under the data page. The calling environment will open a file and the user will prepare the data page as shown in FIG. 18H, where the Vendor Identifier is again taken as “SNDK”.

The Data field indicates that this is “output”, so data page will be updated and Direction field tell the firmware to process the data during reading. Another possibility for firmware is to process the command, update the data page, and write it to the media. Consequently, the firmware will write the 1024 bytes to the media. When the firmware reads the file, it will detect that this an instruction page, then it will read the command and update the data fields appropriately. The caller can verify if the operation has succeeded by reading the file from the media card. Once file is read, the caller can check the Firmware Operation Status field. If the command results in a successfully completed operation, this field will be updated with API_OP_SUCCESS; if not, then it will be updated with some error values such as API_OP_NO_SUCCESS. The amount of data read can also be verified by checking the DSIB field to see whether it has been updated to 512.

Although various aspects of the present invention have been described with respect to specific embodiments, it will be understood that the invention is protected within the full scope of the appended claims.

It is claimed:

1. A memory card structure, comprising:
a non-volatile memory;
a front layer for exchanging instructions with a host to which the card is connected according to a first protocol, wherein the first layer determines whether the data portion of an incoming instruction in the first protocol contains a signature and, in response to determining the absence of said signature, accessing the memory according to the instruction in the first protocol; and,
an application layer, wherein in response to determining that an incoming instruction in the first protocol contains a signature, the incoming instruction is transferred from the front layer to the application wherein an instruction in a second protocol is extracted from the data portion of the incoming instruction and the memory is accessed according to the instruction in the second protocol.

2. The memory card structure of claim 1, wherein said signature is contained in a predetermined section of said data portion.

3. The memory card structure of claim 1, wherein said instruction is in a first protocol having a first command set and wherein the extracted command is from a second command set in a second protocol and does not have a corresponding command in the first command set.

4. The memory card structure of claim 1, wherein said instruction is to access data a first logical address and wherein said determining whether the data portion of the instruction contains a signature is in response the first logical address corresponding to a predetermined logical address.

5. The memory card structure of claim 1, wherein said front layer and said application layer are implemented in firmware.

6. The memory card structure of claim 1, wherein said memory card structure can process multiple such instructions concurrently.

7. The memory card structure of claim 6, wherein said application layer includes multiple applications and wherein said multiple instructions processed concurrently are from more than one of said applications.

8. The memory card structure of claim 1, wherein in response to determining that the incoming instruction is for the transfer of data from the card, the application layer sets a flag for the transfer and transfers from the card data associated with the incoming instruction.

9. The memory card structure of claim 8, wherein in response to a second incoming instruction, re-transferring from the card said data associated with the incoming instruction.

10. The memory card structure of claim 1, wherein said application layer determines whether said data portion further includes data associated with the instruction in the second protocol.

11. The memory card structure of claim 10, wherein said application layer determines whether the data associated with the instruction in the second protocol that is included in said data portion is all of the data associated with the instruction in the second protocol.

12. The memory card structure of claim 11, wherein in response to determining that the data associated with the instruction in the second protocol that is included in said data portion is not all of the data associated with the instruction in the second protocol, the application layer leaves a flag set for the reception of additional data associated with the instruction in the second protocol.
